(19) United States
(12) Patent Application Publication
(10) Pub. No.: US 2015/0168687 A1
(43) Pub. Date: Jun. 18, 2015

(54) IMAGING LENS AND IMAGING APPARATUS EQUIPPED WITH THE IMAGING LENS

(71) Applicant: FUJIFILM Corporation, Tokyo (JP)

(72) Inventors: Masato KONDO, Saitama-ken (JP); Michio CHO, Saitama-ken (JP)

(21) Appl. No.: 14/631,883

(22) Filed: Feb. 26, 2015

Related U.S. Application Data
(63) Continuation of application No. PCT/JP2013/004713, filed on Aug. 5, 2013.
(60) Provisional application No. 61/701,221, filed on Sep. 14, 2012.

(30) Foreign Application Priority Data
Aug. 29, 2012 (JP) 188272/2012

(51) Int. Cl. G02B 13/00; H04N 5/225; H04N 5/44; G02B 9/60

(52) U.S. Cl. CPC G02B 13/0045; G02B 9/60; H04N 5/2254; H04N 5/44

(57) ABSTRACT

An imaging lens is essentially constituted by five lenses, including: a first lens having a positive refractive power and a convex surface toward the object side; a second lens having a concave surface toward the image side; a third lens having a negative refractive power and a concave surface toward the image side; a fourth lens having a convex surface toward the image side; and a fifth lens of a biconcave shape, provided in this order from the object side. The imaging lens satisfies a predetermined conditional formula.

### CROSS REFERENCE TO RELATED APPLICATIONS

The present application is a Continuation of PCT International Application No. PCT/JP2013/004713 filed on Aug. 5, 2013, which claims priority under 35 U.S.C. §119(a) to Japanese Patent Application No. 2012-188272 filed on Aug. 29, 2012 and U.S. Provisional Patent Application No. 61/701,221 filed on Sep. 14, 2012. Each of the above applications is hereby expressly incorporated by reference, in its entirety, into the present application.

### BACKGROUND OF THE INVENTION

1. Technical Field

The present invention is related to a fixed focus imaging lens for forming optical images of subjects onto an imaging element such as a CCD (Charge Coupled Device) and a CMOS (Complementary Metal Oxide Semiconductor). The present invention is also related to an imaging apparatus provided with the imaging lens that performs photography such as a digital still camera, a cellular telephone with a built in camera, a PDA (Personal Digital Assistant), a smart phone, a tablet type terminal, and a portable gaming device.

2. Background Art

Accompanying the recent spread of personal computers in households, digital still cameras capable of inputting image data such as photographed scenes and portraits into personal computers are rapidly becoming available. In addition, many cellular telephones, smart phones, and tablet type terminals are being equipped with camera modules for inputting images. Imaging elements such as CCD's and CMOS's are employed in these devices having photography functions. Recently, miniaturization of these imaging elements is advancing, and there is demand for miniaturization of the entirety of the photography devices as well as imaging lenses to be mounted thereon. At the same time, the number of pixels in imaging elements is increasing, and there is demand for high resolution and high performance of imaging lenses. Performance corresponding to 5 megapixels or greater, and more preferably 8 megapixels or greater, is desired.

In response to such demands, imaging lenses having a five lens configuration, which is a comparatively large number of lenses, may be considered. For example, Chinese Utility Model Publication No. 201903684, International Patent Publication No. 2011/118554, Japanese Unexamined Patent Publication No. 2010-152042 and U.S. Pat. No. 8,305,697 propose imaging lenses, each of which is constituted by: a first lens having a positive refractive power, a second lens having a negative refractive power, a third lens having a negative refractive power, a fourth lens having a positive refractive power, and a fifth lens having a negative refractive power, provided in this order from the object side.

### DISCLOSURE OF THE INVENTION

Here, in imaging lenses constituted by a comparatively large number of lenses and in which shortened total lengths are required to be employed in portable terminals, smart phones, tablet terminals, etc., there is demand for an imaging lens having an even smaller F number and an image size which is sufficiently large to be compatible with imaging elements of approximately the same size as those which had been conventionally utilized, in order to be able to be compatible with a desired resolution, to be realized.

The imaging lenses disclosed in Chinese Utility Model Publication No. 201903684 and International Patent Publication No. 2011/118554 having the five lens configurations do not sufficiently correct aberration or do not have sufficiently small F numbers in order to meet all of these demands. That is, realization of a smaller F number and further improved performance is required in these imaging lenses. The lens disclosed in Japanese Unexamined Patent Publication No. 2010-152042 does not sufficiently correct aberration, and therefore further improved performance is required. In addition, the total length of the lens disclosed in U.S. Pat. No. 8,305,697 is not sufficiently short. Therefore, a further shortening of the total length is required.

The present invention has been developed in view of the foregoing points. The object of the present invention is to provide an imaging lens that has a small F number while maintaining a sufficiently large image size that enables realization of a desired resolution, a shortened total length, and high imaging performance from a central angle of view to peripheral angles of view. It is another object of the present invention to provide an imaging apparatus equipped with the lens, which is capable of obtaining high resolution photographed images.

An imaging lens of the present invention consists essentially of five lenses, including:

a first lens having a positive refractive power and a convex surface toward the object side;

a second lens having a concave surface toward the image side;

a third lens having a negative refractive power and a concave surface toward the image side;

a fourth lens having a convex surface toward the image side; and

a fifth lens of a biconcave shape, provided in this order from the object side;

the imaging lens satisfying the following conditional formula:

1.58<f/f1<3 (1-2)

wherein f is the focal length of the entire system, and f1 is the focal length of the first lens.

According to the imaging lens of the present invention, the configuration of each lens element is optimized within a lens configuration having five lenses as a whole. Therefore, a lens system that has a short total length while having high resolution performance can be realized. In addition, chromatic aberration can be favorably corrected while realizing a shortening of the total length, by the third lens of the imaging lens of the present invention having a negative refractive power. In addition, various aberrations can be favorably corrected and a shortening of the total length can be favorably realized, by the imaging lens of the present invention satisfying Conditional Formula (1-2).

Note that in the imaging lens of the present invention, the expression “consists essentially of five lenses” means that the imaging lens of the present invention may also include lenses that practically have no power, optical elements other than lenses such as a stop and a cover glass, and mechanical components such as lens flanges, a lens barrel, a camera shake correcting mechanism, etc., in addition to the five lenses. In addition, the shapes of the surfaces and the signs of the refractive powers of the lenses will be considered as those in the paraxial region for lenses that include aspherical surfaces.

The optical performance of the imaging lens of the present invention can be further improved by adopting the following favorable configurations.

In the imaging lens of the present invention, it is preferable for the fourth lens to be of a meniscus shape. In addition, it is preferable for the fourth lens to have a positive refractive power.

In the imaging lens of the present invention, it is preferable for the second lens to have a negative refractive power, and for the second lens to be of a biconcave shape.

In the imaging lens of the present invention, it is preferable for the third lens to have a negative refractive power.

It is preferable for the imaging lens of the present invention to satisfy one of Conditional Formulae (1-3) through (6-1) below. Note that as a preferable aspect of the present invention, the imaging lens of the present invention may satisfy any one or arbitrary combinations of Conditional Formulae (1-3) through (6-1).

1.58<f/f1<2 (1-3)

−3<f/f2<−0.7 (2)

−1.5<f/f2<−0.75 (2-1)

−0.4<f/f3<0 (3)

−0.3<f/f3<−0.12 (3-1)

1.5<f/f4<2.3 (4)

1.7<f/f4<2.1 (4-1)

−2.5<f/f5<−1.5 (5)

−2.2<f/f5<−1.7 (5-1)

νd3<30 (6)

νd3<26(6-1)

wherein f1 is the focal length of the first lens, f2 is the focal length of the second lens, f3 is the focal length of the third lens, f4 is the focal length of the fourth lens, f5 is the focal length of the fifth lens, and νd3 is the Abbe's number of the third lens with respect to the d line.

An imaging apparatus of the present invention is equipped with the imaging lens of the present invention.

The imaging apparatus of the present invention is capable of obtaining high resolution image signals, based on high resolution optical images obtained by the imaging lens of the present invention.

According to the imaging lens of the present invention, the configuration of each lens element is optimized within a lens configuration having five lenses as a whole, and the shapes of the first lens and the fifth lens are favorably configured in particular. Therefore, a lens system having a small F number, a short total length, and a large image size, and further, high imaging performance from a central angle of view to peripheral angles of view, can be realized.

The imaging apparatus of the present invention outputs image signals corresponding to optical images formed by the imaging lens of the present invention having high imaging performance. Therefore, the imaging apparatus of the present invention is capable of obtaining high resolution photographed images.

### BRIEF DESCRIPTION OF THE DRAWINGS

FIG. 1 is a sectional diagram that illustrates a first example of the configuration of an imaging lens according to an embodiment of the present invention, and corresponds to a lens of Example 1.

FIG. 2 is a sectional diagram that illustrates a second example of the configuration of an imaging lens according to an embodiment of the present invention, and corresponds to a lens of Example 2.

FIG. 3 is a sectional diagram that illustrates a third example of the configuration of an imaging lens according to an embodiment of the present invention, and corresponds to a lens of Example 3.

FIG. 4 is a sectional diagram that illustrates a fourth example of the configuration of an imaging lens according to an embodiment of the present invention, and corresponds to a lens of Example 4.

FIG. 5 is a sectional diagram that illustrates a fifth example of the configuration of an imaging lens according to an embodiment of the present invention, and corresponds to a lens of Example 5.

FIG. 6 is a sectional diagram that illustrates a sixth example of the configuration of an imaging lens according to an embodiment of the present invention, and corresponds to a lens of Example 6.

FIG. 7 is a sectional diagram that illustrates the configuration of an imaging lens corresponding to a lens of Reference Example 7.

FIG. 8 is a sectional diagram that illustrates an eighth example of the configuration of an imaging lens according to an embodiment of the present invention, and corresponds to a lens of Example 8.

FIG. 9 is a sectional diagram that illustrates the configuration of an imaging lens corresponding to a lens of Reference Example 9.

FIG. 10 is a sectional diagram that illustrates the configuration of an imaging lens corresponding to a lens of Reference Example 10.

FIG. 11 is a sectional diagram that illustrates the configuration of an imaging lens corresponding to a lens of Reference Example 11.

FIG. 12 is a diagram that illustrates the paths of light rays that pass through the imaging lens illustrated in FIG. 1.

A through D of FIG. 13 are diagrams that illustrate aberrations of the imaging lens of Example 1, wherein A illustrates spherical aberration, B illustrates astigmatism (field curvature), C illustrates distortion, and D illustrates lateral chromatic aberration.

A through D of FIG. 14 are diagrams that illustrate aberrations of the imaging lens of Example 2, wherein A illustrates spherical aberration, B illustrates astigmatism (field curvature), C illustrates distortion, and D illustrates lateral chromatic aberration.

A through D of FIG. 15 are diagrams that illustrate aberrations of the imaging lens of Example 3, wherein A illustrates spherical aberration, B illustrates astigmatism (field curvature), C illustrates distortion, and D illustrates lateral chromatic aberration.

A through D of FIG. 16 are diagrams that illustrate aberrations of the imaging lens of Example 4, wherein A illustrates spherical aberration, B illustrates astigmatism (field curvature), C illustrates distortion, and D illustrates lateral chromatic aberration.

A through D of FIG. 17 are diagrams that illustrate aberrations of the imaging lens of Example 5, wherein A illustrates spherical aberration, B illustrates astigmatism (field curvature), C illustrates distortion, and D illustrates lateral chromatic aberration.

A through D of FIG. 18 are diagrams that illustrate aberrations of the imaging lens of Example 6, wherein A illustrates spherical aberration, B illustrates astigmatism (field curvature), C illustrates distortion, and D illustrates lateral chromatic aberration.

A through D of FIG. 19 are diagrams that illustrate aberrations of the imaging lens of Reference Example 7, wherein A illustrates spherical aberration, B illustrates astigmatism (field curvature), C illustrates distortion, and D illustrates lateral chromatic aberration.

A through D of FIG. 20 are diagrams that illustrate aberrations of the imaging lens of Example 8, wherein A illustrates spherical aberration, B illustrates astigmatism (field curvature), C illustrates distortion, and D illustrates lateral chromatic aberration.

A through D of FIG. 21 are diagrams that illustrate aberrations of the imaging lens of Reference Example 9, wherein A illustrates spherical aberration, B illustrates astigmatism (field curvature), C illustrates distortion, and D illustrates lateral chromatic aberration.

A through D of FIG. 22 are diagrams that illustrate aberrations of the imaging lens of Reference Example 10, wherein A illustrates spherical aberration, B illustrates astigmatism (field curvature), C illustrates distortion, and D illustrates lateral chromatic aberration.

A through D of FIG. 23 are diagrams that illustrate aberrations of the imaging lens of Reference Example 11, wherein A illustrates spherical aberration, B illustrates astigmatism (field curvature), C illustrates distortion, and D illustrates lateral chromatic aberration.

FIG. 24 is a diagram that illustrates a cellular telephone as an imaging apparatus equipped with the imaging lens of the present invention.

FIG. 25 is a diagram that illustrates a smart phone as an imaging apparatus equipped with the imaging lens of the present invention.

### BEST MODE FOR CARRYING OUT THE INVENTION

Hereinafter, embodiments of the present invention will be described in detail with reference to the attached drawings.

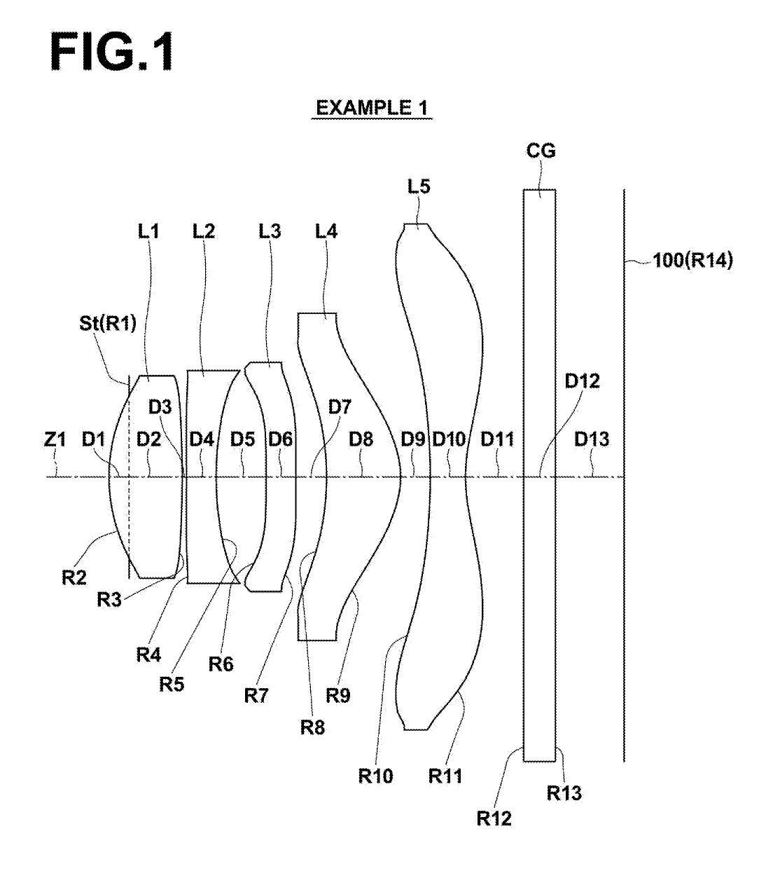

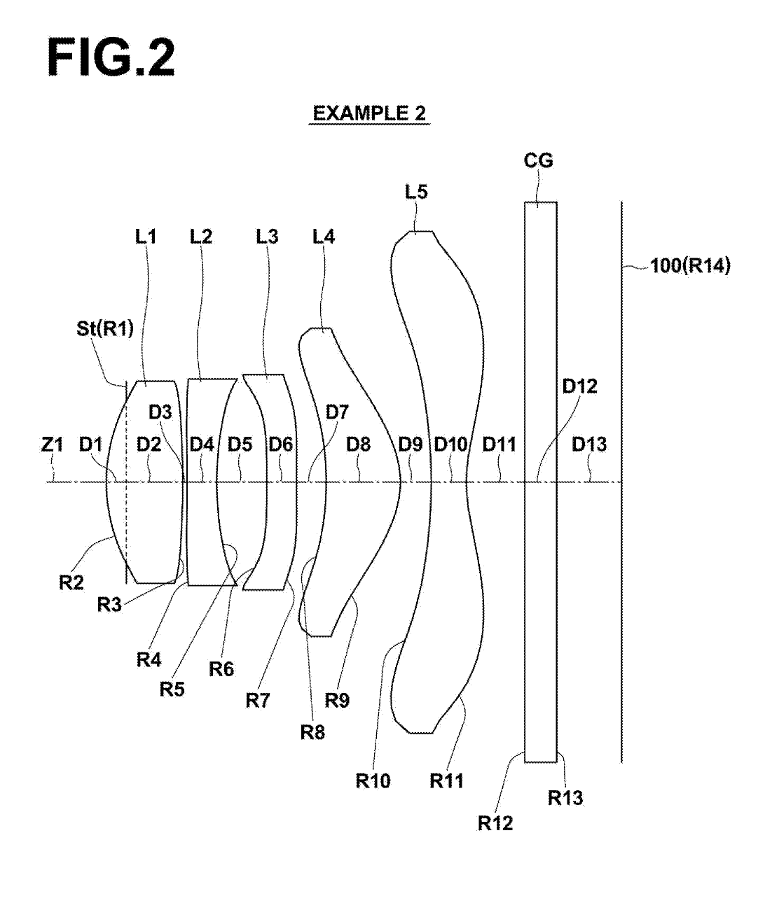

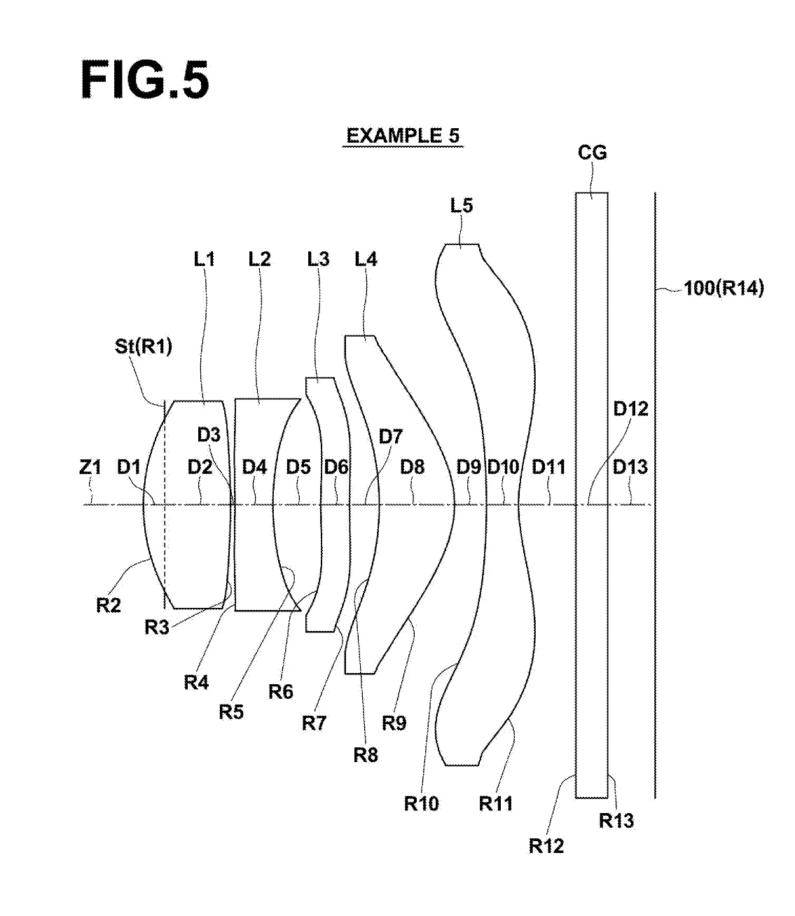

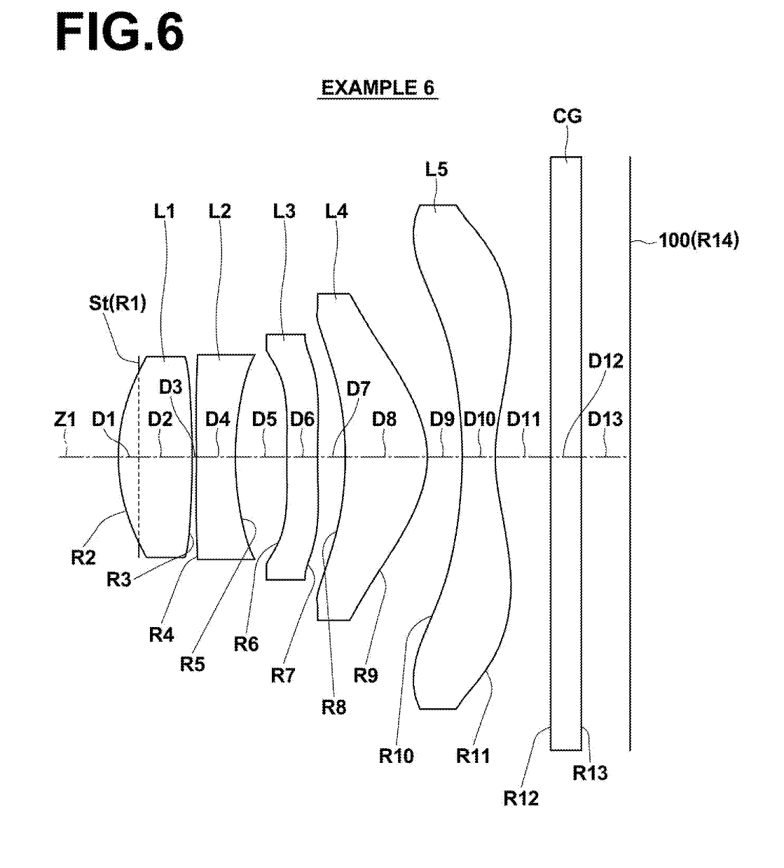

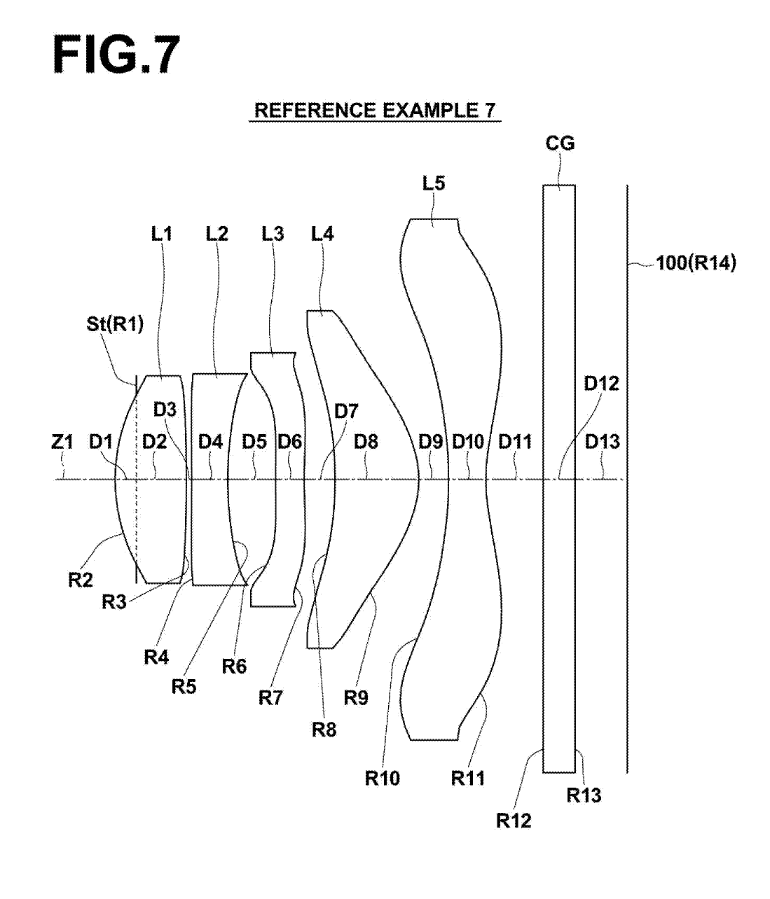

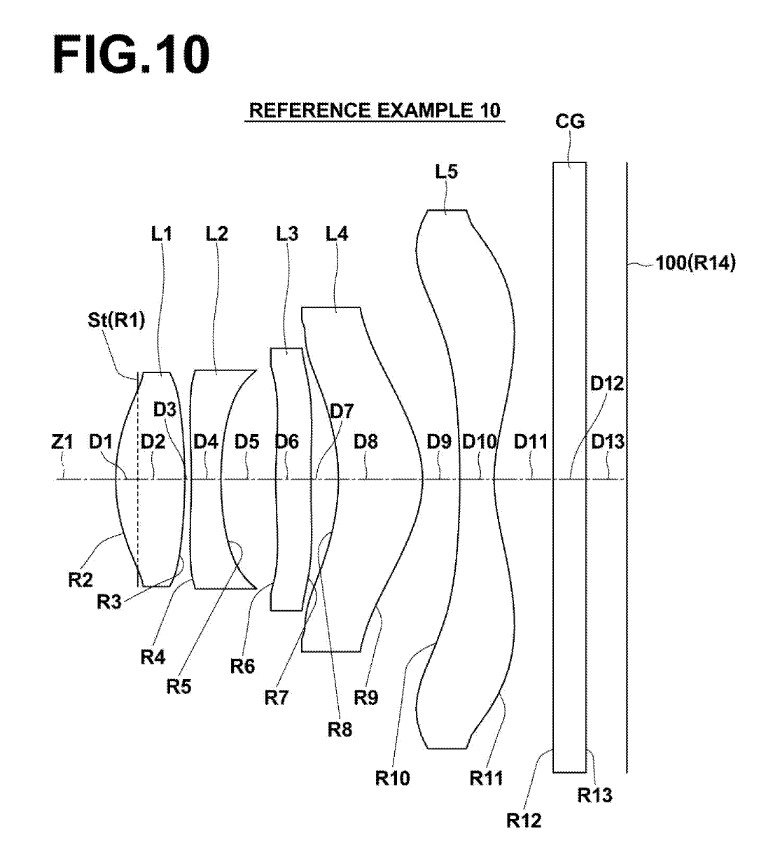

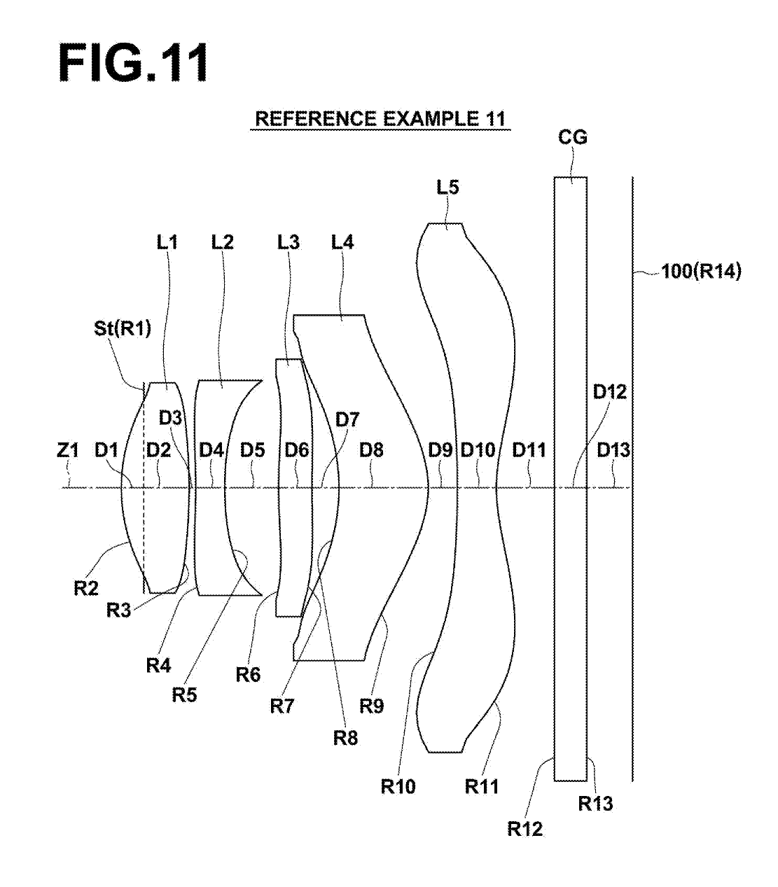

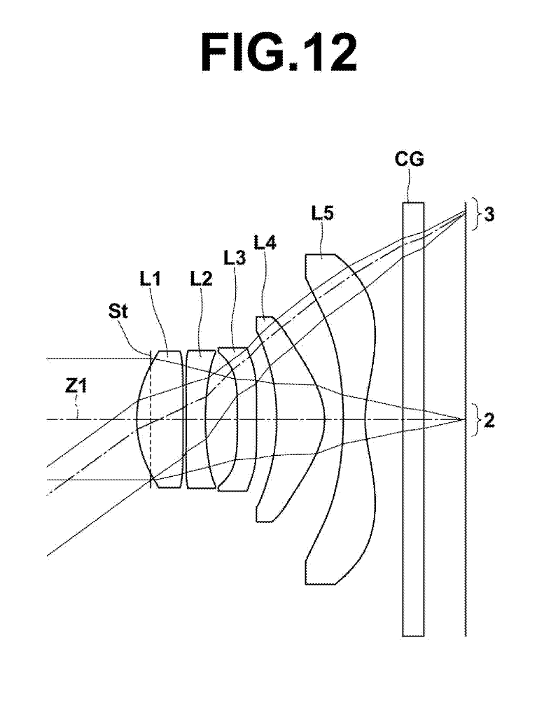

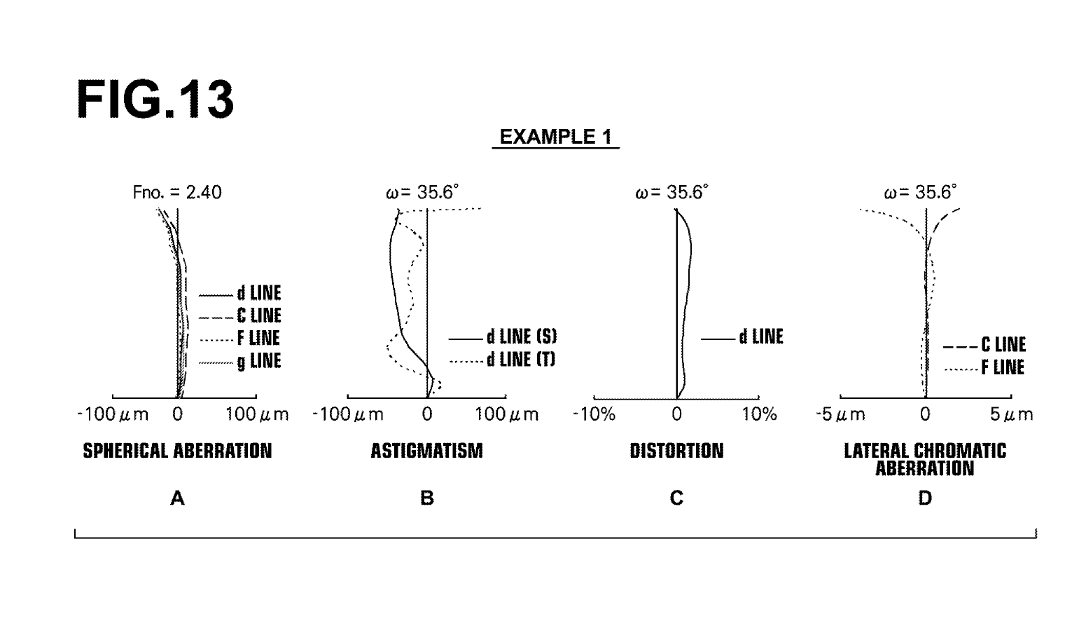

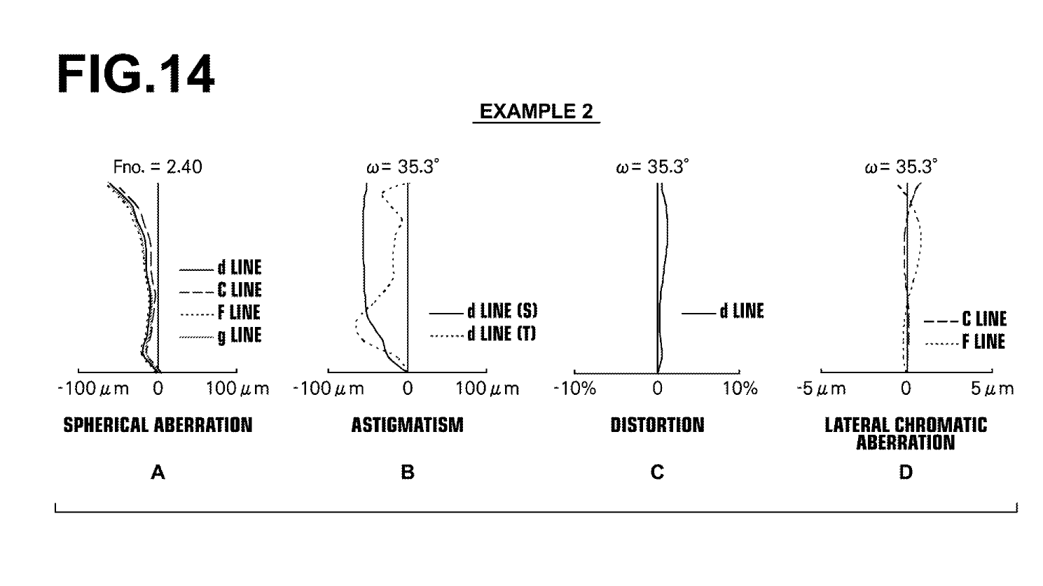

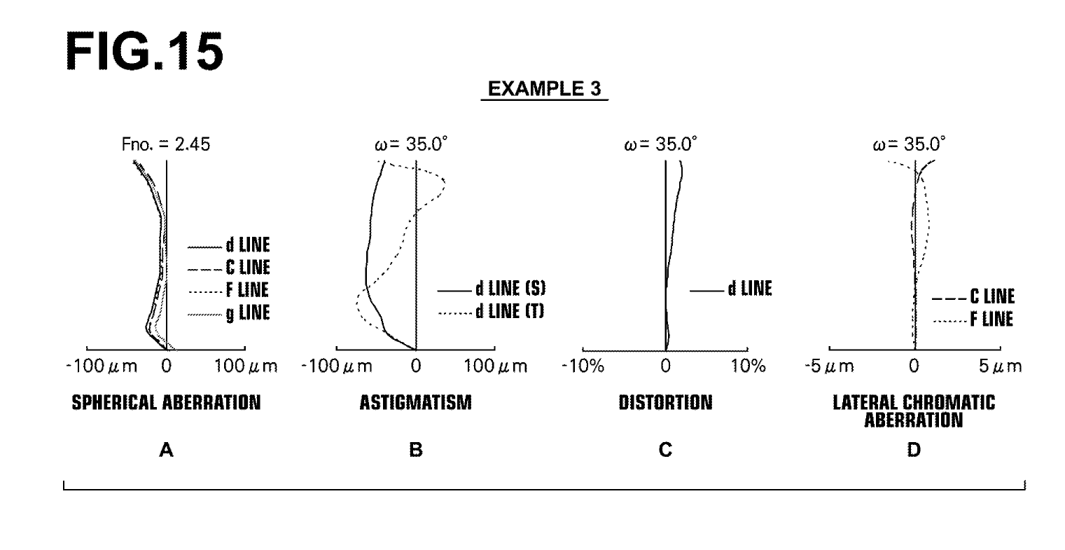

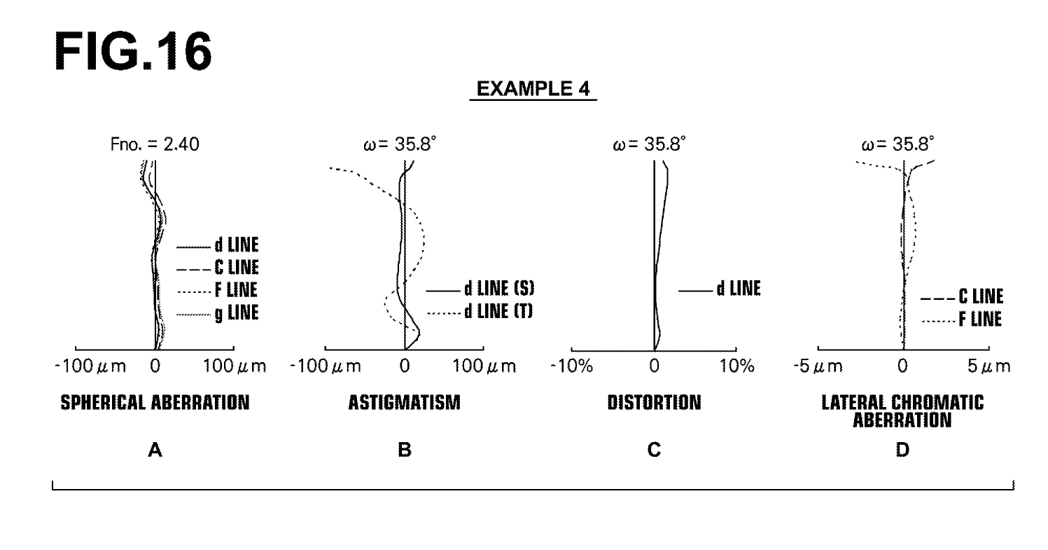

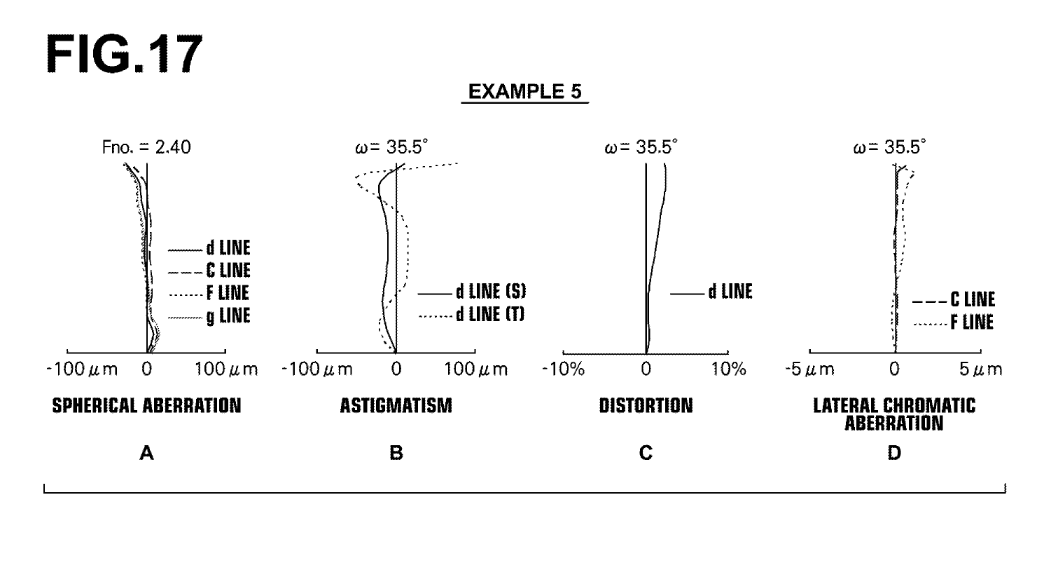

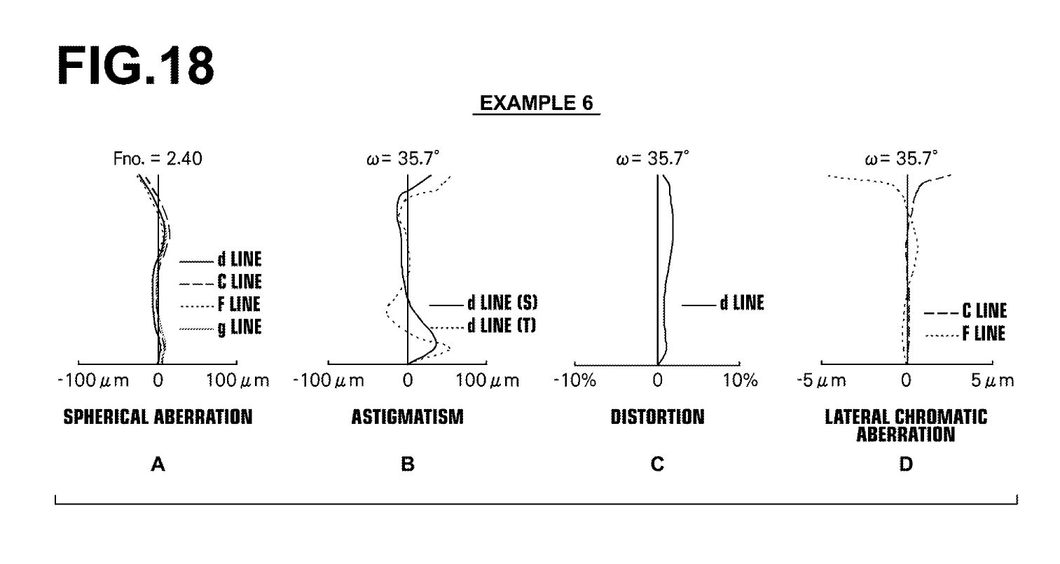

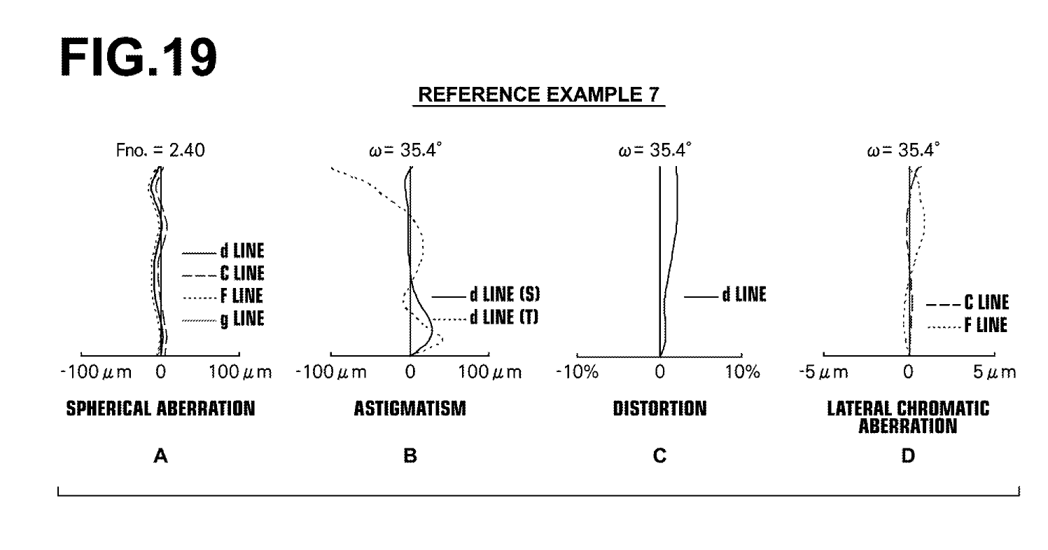

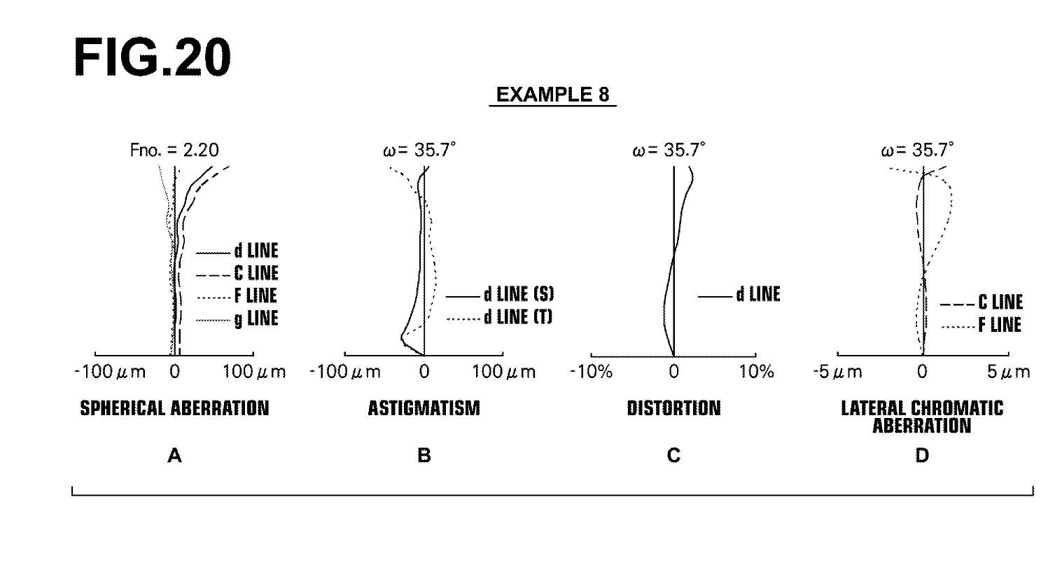

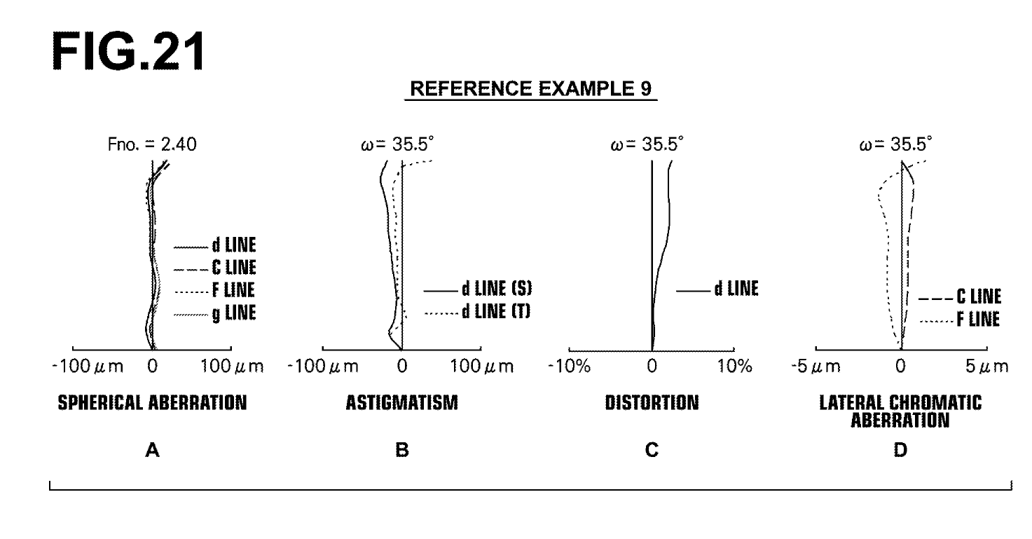

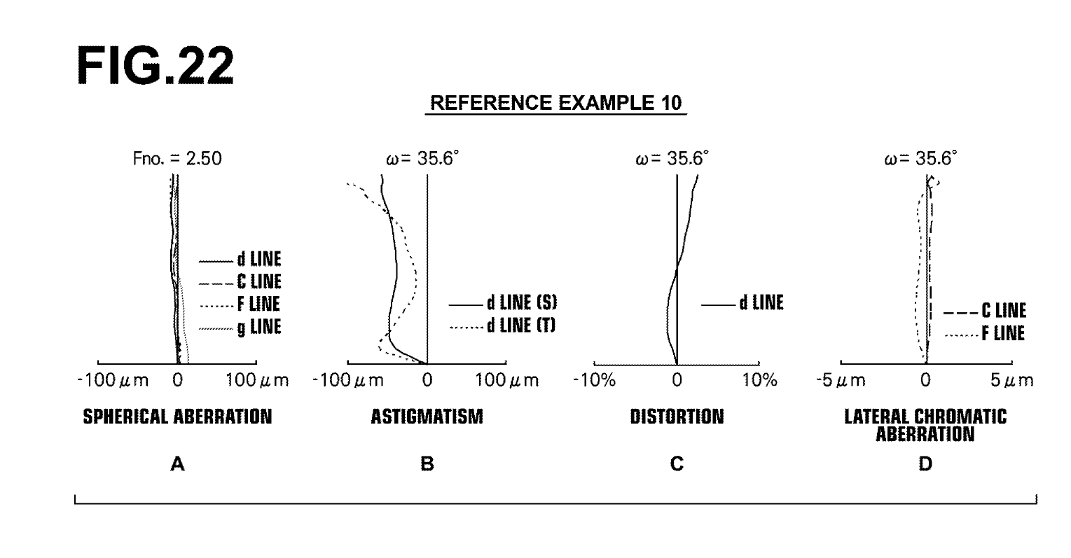

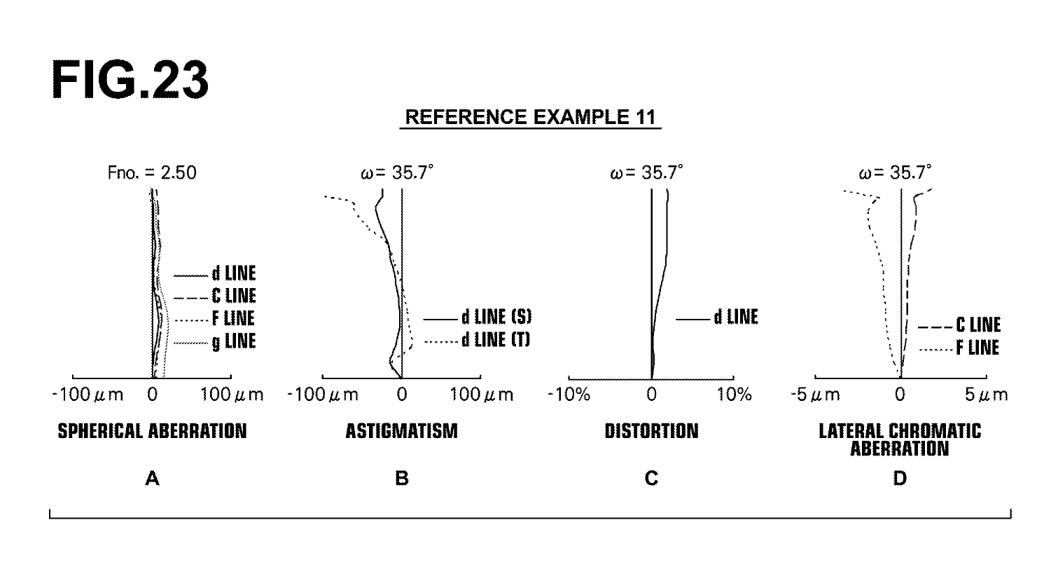

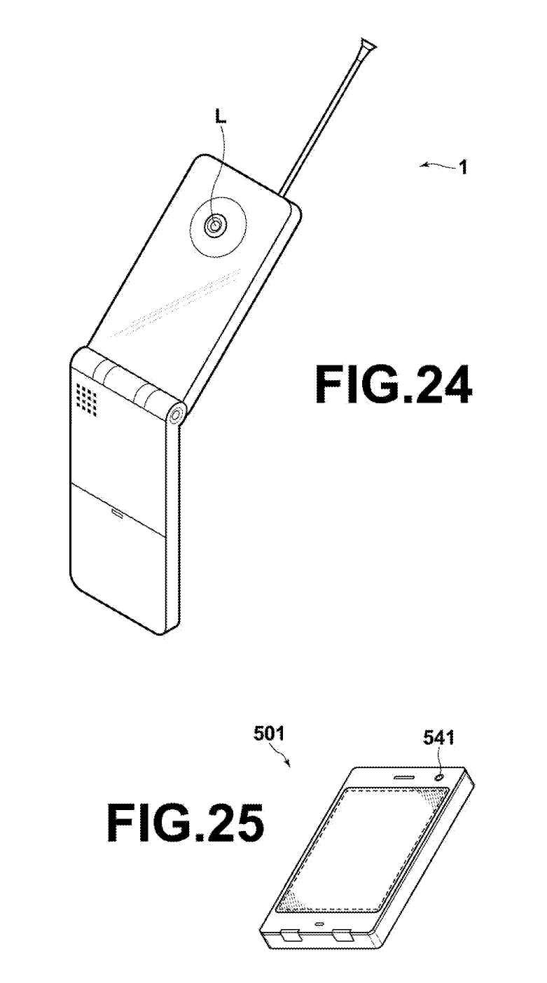

FIG. 1 illustrates a first example of the configuration of an imaging lens according to an embodiment of the present invention. This example corresponds to the lens configuration of Numerical Example 1 (Table 1 and Table 2), to be described later. Similarly, FIG. 2 through FIG. 6 and FIG. 8 are sectional diagrams that illustrate second through sixth and eighth examples of lens configurations that correspond to Numerical Examples 2 through 6 and 8 (Table 3 through Table 12, Table 15 and Table 16). Note that FIG. 7 and FIG. 9 through FIG. 11 are sectional diagrams that illustrate lens configurations of Reference Example 7 and Reference Examples 9 through 11 (Table 13, Table 14 and Tables 17 through 22). In FIGS. 1 through 11, the symbol Ri represents the radii of curvature of ith surfaces, i being lens surface numbers that sequentially increase from the object side to the image side (imaging side), with the surface of a lens element most toward the object side designated as first. The symbol Di represents the distances between an ith surface and an i+1st surface along an optical axis Z1. Note that the basic configurations of the examples are the same, and therefore a description will be given of the imaging lens of FIG. 1 as a base, and the examples illustrated in FIGS. 2 through 6 and FIG. 8 as well as the Reference Examples illustrated in FIG. 7 and FIGS. 9 through 11 will also be described as necessary. In addition, FIG. 12 is a diagram that illustrates the paths of light rays that pass through the imaging lens L of FIG. 1, and illustrates the paths of axial light beams 2 from an object at a distance of infinity and light beams 3 at a maximum angle of view. The imaging lens L of the embodiment of the present invention is favorably employed in various imaging devices that employ imaging elements such as a CCD and a CMOS. The imaging lens L of the embodiment of the present invention is particularly favorable for use in comparatively miniature portable terminal devices, such as a digital still camera, a cellular telephone with a built in camera, a smart phone, a tablet type terminal, and a PDA. The imaging lens L is equipped with a first lens L1, a second lens L2, a third lens L3, a fourth lens L4, and a fifth lens L5, provided in this order from the object side.

FIG. 24 schematically illustrates a cellular telephone as an imaging apparatus 1 according to an embodiment of the present invention. The imaging apparatus 1 of the embodiment of the present invention is equipped with the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface R14) of the imaging lens L.

FIG. 25 schematically illustrates a smart phone as an imaging apparatus 501 according to an embodiment of the present invention. The imaging apparatus 501 of the embodiment of the present invention is equipped with a camera section 541 having the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

Various optical members CG may be provided between the fifth lens L5 and the imaging element 100, depending on the configuration of the camera to which the lens is applied. A planar optical member such as a cover glass for protecting the imaging surface and an infrared cutoff filter may be provided, for example. In this case, a planar cover glass having a coating having a filtering effect such as an infrared cutoff filter coating or an ND filter coating, or a material that exhibits similar effects, may be utilized as the optical member CG.

Alternatively, the optical member CG may be omitted, and a coating may be administered on the fifth lens L5 to obtain the same effect as that of the optical member CG. Thereby, the number of parts can be reduced, and the total length can be shortened.

It is preferable for the imaging lens L to be equipped with an aperture stop St positioned at the object side of the surface of the first lens L1 toward the object side. By positioning the aperture stop St at the object side of the surface of the first lens L1 toward the object side in this manner, increases in the incident angles of light rays that pass through the optical system and enter the image formation plane (imaging element) can be suppressed, particularly at peripheral portions of an imaging region. Note that the expression “positioned at the object side of the surface of the first lens toward the object side” means that the position of the aperture stop in the direction of the optical axis is at the same position as the intersection of marginal axial rays of light and the surface of the first lens L1 toward the object side, or more toward the object side than this position. In the embodiments, the lenses of Examples 1 through 6 and 8 (FIGS. 1 through 6 and 8) are examples of configurations in which the aperture stop St is positioned at the object side of the surface of the first lens L1 toward the object side.

In the embodiments of the present invention, the aperture stop St is positioned at the image side of the apex of the surface of the first lens L1. However, the present invention is not limited to this configuration, and the aperture stop St may be positioned at the object side of the apex of the surface of the first lens L1. A case in which the aperture stop St is positioned at the object side of the apex of the surface of the first lens L1 is somewhat disadvantageous from the viewpoint of securing peripheral light compared to a case in which the aperture stop St is positioned at the image side of the apex of the surface of the first lens L1. However, increases in the incident angles of light rays at peripheral portions of the imaging region that enter the image formation plane (imaging element) can be more favorably suppressed.

In the imaging lens L, the first lens L1 has a convex surface toward the object side in the vicinity of the optical axis, and has a positive refractive power in the vicinity of the optical axis. Thereby, the total length can be favorably shortened. In addition, it is preferable for the first lens L1 to be of a biconvex shape in the vicinity of the optical axis as in the imaging lens of Example 1 illustrated in FIG. 1. In the case that the first lens L1 is of a biconvex shape in the vicinity of the optical axis, the generation of spherical aberration will be suppressed. Therefore, correction of spherical aberration will be facilitated.

The second lens L2 has a concave surface toward the image side in the vicinity of the optical axis. In addition, it is preferable for the second lens L2 to have a negative refractive power in the vicinity of the optical axis. In the case that the second lens L2 has a negative refractive power in the vicinity of the optical axis, chromatic aberration can be favorably corrected. In addition, it is preferable for the second lens L2 to be of a biconcave shape in the vicinity of the optical axis, as in the imaging lens of Example 1. In the case that the second lens L2 is of a biconvex shape in the vicinity of the optical axis, correction of spherical aberration will be facilitated.

The third lens L3 has a concave surface toward the image side in the vicinity of the optical axis. By providing the second lens having a concave surface toward the image side in the vicinity of the optical axis and the third lens L3 having a concave surface toward the image side in the vicinity of the optical axis adjacent to each other at the image side of the first lens L1, which has a positive refractive power in the vicinity of the optical axis and a convex surface toward the object side in the vicinity of the optical axis, correction of chromatic aberration, which is likely to be generated at the first lens L1 having the above configuration, will be facilitated. At the same time, an image size that satisfies the requirements for a desired resolution can be maintained, and the total length can be shortened.

In addition, the third lens L3 has a negative refractive power in the vicinity of the optical axis. By this configuration being adopted, chromatic aberration can be favorably corrected, while a shortening of the total length can be favorably realized. In the case that the third lens L3 is of a biconcave shape in the vicinity of the optical axis as in the imaging lens of Example 1, chromatic aberration and spherical aberration can be favorably corrected, which is preferable. Alternatively, the third lens L3 may be configured to have a negative refractive power in the vicinity of the optical axis and to be of a meniscus shape in the vicinity of the optical axis. In this case, the negative refractive power of the third lens L3 will enable chromatic aberration to be favorably corrected, while the convex surface shape of the meniscus shape of the third lens L3 will enable the total length to be more favorably shortened. Meanwhile, in Reference Examples 9 through 11, the third lens L3 is configured to have a positive refractive power in the vicinity of the optical axis. In this case, the positive refractive power of the third lens L3 will enable the total length to be favorably shortened. In addition, the third lens L3 may be configured to have a positive refractive power in the vicinity of the optical axis and to be of a meniscus shape in the vicinity of the optical axis. In this case, the positive refractive power of the third lens L3 will enable the total length to be favorably shortened, while the concave surface shape of the meniscus shape of the third lens L3 will enable spherical aberration and chromatic aberration to be favorably corrected.

The fourth lens L4 has a convex surface toward the image side in the vicinity of the optical axis. Thereby, astigmatism can be favorably corrected. It is preferable for the fourth lens L4 to be of a meniscus shape having a convex surface toward the image side as in the imaging lens of Example 1, in order to cause this advantageous effect to become more prominent. In addition, it is preferable for the fourth lens L4 to have a positive refractive power in the vicinity of the optical axis. By adopting this configuration, increases in the incident angles of light rays that pass through the optical system and enter the image formation surface (imaging element) can be favorably suppressed at the peripheral portions of the imaging region.

The fifth lens L5 has a negative refractive power in the vicinity of the optical axis. If the first lens L1 through the fourth lens L4 are considered to be a single positive lens group, the imaging lens will be of a telephoto type configuration as a whole, by the fifth lens L5 having a negative refractive power in the vicinity of the optical axis. For this reason, the rearward principal point of the imaging lens as a whole can be more toward the object side because the imaging lens L is of a telephoto configuration as a whole, and the total length can be favorably shortened. In addition, the fifth lens L5 is of a biconcave shape in the vicinity of the optical axis. Excessive increases in the absolute values of the radii of curvature of the surfaces of the fifth lens L5 can be suppressed, while the negative refractive power of the fifth lens L5 can be sufficiently increased, by the fifth lens being of a biconcave shape in the vicinity of the optical axis. In addition, field curvature can be favorably corrected, by the fifth lens L5 being of a biconcave shape in the vicinity of the optical axis.

In addition, it is preferable for the surface toward the image side of the fifth lens L5 to have at least one inflection point within the effective diameter thereof. The “inflection point” on the surface of the fifth lens L5 toward the image side refers to a point at which the shape of the surface of the fifth lens L5 toward the image side changes from a convex shape to a concave shape (or from a concave shape to a convex shape) with respect to the image side. The position of the inflection point may be any arbitrary position in an outwardly radial direction from the optical axis up to the effective diameter of the surface of the fifth lens L5 toward the image side. It is preferable for the inflection point to be positioned at the peripheral portion of the surface of the fifth lens L5 toward the image side. Increases in the incident angles of light rays that pass through the optical system at peripheral angles of view into the image formation plane (imaging element) can be suppressed, particularly at the peripheral portions of an imaging region, by the surface of the fifth lens L5 toward the image side being of a shape having at least one inflection point thereon. Note that here, the peripheral portion refers to a portion radially outward from approximately 40% of the effective diameter.

According to the imaging lens L described above, the configuration of each lens element, that is, the first through fifth lenses, is optimized within a lens configuration having five lenses as a whole. Therefore, a lens system having a small F number, a short total length, a large image size, and high resolution performance can be realized.

In addition, in the case that the lens configurations of each of the first lens L1 through the fifth lens L5 are set such that the full angle of view 2w is 60 degrees or greater as in the imaging lenses of the Examples illustrated in FIGS. 1 through 6 and 8, the full angle of view 2w will be an appropriate value. Therefore, the imaging lens L may be favorably applied for use with imaging apparatuses which are often employed to perform photography at close distances, such as cellular telephones.

It is preferable for at least one of the surfaces of each of the first lens L1 through the fifth lens L5 of the imaging lens L to be an aspherical surface, in order to improve performance.

In addition, it is preferable for each of the first lens L1 through the fifth lens L5 that constitute the imaging lens L to be a single lens, not a cemented lens. If all of the lenses are single lenses, the number of surfaces in contact with air will be greater than a case in which some of the lenses are cemented lenses. Therefore, the degree of freedom in the design of each lens will increase. As a result, the total length can be favorably shortened.

Next, the operation and effects of conditional formulae related to the imaging lens L will be described in greater detail.

First, the focal length f1 of the first lens L1 and the focal length f of the entire system satisfy Conditional Formula (1) below.

1.45<f/f1<3 (1)

Conditional Formula (1) defines a preferable range of numerical values for the focal length f of the entire system with respect to the focal length f1 of the first lens L1. In the case that the value of f/f1 is less than the lower limit defined in Conditional Formula (1), the positive refractive power of the first lens L1 will become excessively weak with respect to the refractive power of the entire system, it will become difficult to sufficiently correct various aberrations, and shortening of the total length while maintaining a small F number will become difficult. In the case that the value of f/f1 is greater than the upper limit defined in Conditional Formula (1), the positive refractive power of the first lens L1 will become excessively strong with respect to the refractive power of the entire system, which is disadvantageous, particularly from the viewpoint of correcting spherical aberration. A small F number can be maintained while spherical aberration can be favorably corrected and the total length can be favorably shortened, by the range defined in Conditional Formula (1) being satisfied. It is more preferable for Conditional Formula (1-1) below to be satisfied, in order to cause these advantageous effects to become more prominent. In addition, in the case that the lower limit of Conditional Formula (1-2) is satisfied, the advantageous effects with respect to shortening of the total length and favorable correction of various aberrations will become more prominent. For this reason, it is preferable for Conditional Formula (1-2) to be satisfied, because various aberrations such as spherical aberration can be more favorably corrected, a small F number can be maintained, and a shortening of the total length can be favorably realized. It is more preferable for Conditional Formula (1-3) to be satisfied, in order to cause these advantageous effects to become even more prominent.

1.45<f/f1<2 (1-1)

1.58<f/f1<3 (1-2)

1.58<f/f1<2 (1-3)

In addition, it is preferable for the focal length f of the entire system and the focal length f2 of the second lens L2 to satisfy Conditional Formula (2) below:

−3<f/f2<−0.7 (2)

Conditional Formula (2) defines a preferable range of numerical values for the focal length f of the entire system with respect to the focal length f2 of the second lens L2. In the case that the value of f/f2 is less than the lower limit defined in Conditional Formula (2), the refractive power of the second lens L2 will become excessively strong with respect to the positive refractive power of the entire system, and it will become difficult to sufficiently correct various aberrations, maintain a small F number, and shorten the total length. In the case that the value of f/f2 is greater than the upper limit defined in Conditional Formula (2), the refractive power of the second lens L2 will become excessively weak with respect to the refractive power of the entire system, and correction of chromatic aberration will become difficult. For these reasons, a small F number can be maintained, the total length can be shortened, and various aberrations such as chromatic aberration can be favorably corrected, by the range defined in Conditional Formula (2) being satisfied. It is more preferable for Conditional Formula (2-1) to be satisfied, in order to cause these advantageous effects to become more prominent.

−1.5<f/f2<−0.75 (2-1)

In addition, it is preferable for the focal length f of the entire system and the focal length f3 of the third lens L3 to satisfy Conditional Formula (3) below:

−0.4<f/f3<0 (3)

Conditional Formula (3) defines a preferable range of numerical values for the focal length f of the entire system with respect to the focal length f3 of the third lens L3. In the case that the value of f/f3 is less than the lower limit defined in Conditional Formula (3), the refractive power of the third lens L3 will become excessively strong with respect to the refractive power of the entire system, and it will become difficult to sufficiently correct various aberrations, maintain a small F number, and shorten the total length. In the case that the value of f/f3 is greater than the upper limit defined in Conditional Formula (3), the refractive power of the third lens L3 will become excessively weak with respect to the refractive power of the entire system, and correction of chromatic aberration will become difficult. For these reasons, a small F number can be maintained, the total length can be shortened, and various aberrations such as chromatic aberration can be favorably corrected, by the range defined in Conditional Formula (3) being satisfied. It is more preferable for Conditional Formula (3-1) to be satisfied, in order to cause these advantageous effects to become more prominent.

−0.3<f/f2<−0.12 (3-1)

In addition, it is preferable for the focal length f of the entire system and the focal length f4 of the fourth lens L4 to satisfy Conditional Formula (4) below:

1.5<f/f4<2.3 (4)

Conditional Formula (4) defines a preferable range of numerical values for the focal length f of the entire system with respect to the focal length f4 of the fourth lens L4. The refractive power of the fourth lens L4 will not become excessively weak with respect to the refractive power of the entire system, by the lower limit of Conditional Formula (4) being satisfied. As a result, increases in the incident angles of light rays that pass through the optical system and enter the image formation plane (imaging element) can be favorably suppressed at the peripheral portions of the imaging region. In the case that the value of f/f4 is greater than the upper limit defined in Conditional Formula (4), the refractive power of the fourth lens L4 will become excessively strong with respect to the refractive power of the entire system, and correction of field curvature will become difficult. For these reasons, increases in the incident angles of light rays that pass through the optical system and enter the image formation plane (imaging element) can be favorably suppressed at the peripheral portions of the imaging region, and field curvature can be favorably corrected, by the range defined in Conditional Formula (4) being satisfied. It is more preferable for Conditional Formula (4-1) to be satisfied, in order to cause these advantageous effects to become more prominent.

1.7<f/f4<2.1 (4-1)

In addition, it is preferable for the focal length f of the entire system and the focal length f5 of the fifth lens L5 to satisfy Conditional Formula (5) below:

−2.5<f/f5<−1.5 (5)

Conditional Formula (5) defines a preferable range of numerical values for the focal length f of the entire system with respect to the focal length f5 of the fifth lens L5. The refractive power of the fifth lens L5 will not become excessively strong with respect to the refractive power of the entire system, by the lower limit of Conditional Formula (5) being satisfied. As a result, increases in the incident angles of light rays that pass through the optical system and enter the image formation plane (imaging element) can be favorably suppressed at the peripheral portions of the imaging region. In the case that the value of f/f5 is greater than the upper limit defined in Conditional Formula (5), the refractive power of the fifth lens L5 will become excessively weak with respect to the refractive power of the entire system, and correction of field curvature will become difficult. For these reasons, increases in the incident angles of light rays that pass through the optical system and enter the image formation plane (imaging element) can be favorably suppressed at the peripheral portions of the imaging region, and field curvature can be favorably corrected, by the range defined in Conditional Formula (5) being satisfied. It is more preferable for Conditional Formula (5-1) to be satisfied, in order to cause these advantageous effects to become more prominent.

−2.2<f/f5<−1.7 (5-1)

In addition, it is preferable for the Abbe's number νd3 of the third lens L3 with respect to the d line to satisfy Conditional Formula (6) below:

νd3<30 (6)

Conditional Formula (6) defines a preferable range of numerical values for the Abbe's number νd3 of the third lens L3 with respect to the d line. In the case that the value of νd3 is greater than the upper limit defined in Conditional Formula (6), correction of longitudinal chromatic aberration and lateral chromatic aberration will become difficult. The third lens L3 can be formed by a high dispersion material by satisfying Conditional Formula (6). As a result, longitudinal chromatic aberration and lateral chromatic aberration can be favorably corrected. From this viewpoint, it is more preferable for Conditional Formula (6-1) below to be satisfied.

νd3<26 (6-1)

Next, the imaging lenses of Example 2 through Example 6 and Example 8 of the present invention, as well as the imaging lenses of Reference Example 7 and Reference Examples 9 through 11 will be described in detail with reference to FIGS. 2 through 11. Note that each of the imaging lenses of Example 2 through Example 6 and Example 8 of the present invention consist essentially of a first lens L1 having a positive refractive power and a convex surface toward the object side, a second lens L2 having a concave surface toward the image side, a third lens L3 having a negative refractive power and a concave surface toward the image side, a fourth lens L4 having a convex surface toward the image side, and a fifth lens L5 of a biconcave shape. For this reason, only the other detailed configurations of each lens of Example 2 through Example 6 and Example 8 will be described. In addition, the operational effects of configurations which are common among Example 2 through Example 6 and Example 8 are the same. Therefore, the configurations and the operational effects thereof will be described for lower numbered Examples, and redundant descriptions of the common configurations and the operational effects thereof will be omitted for the other embodiments.

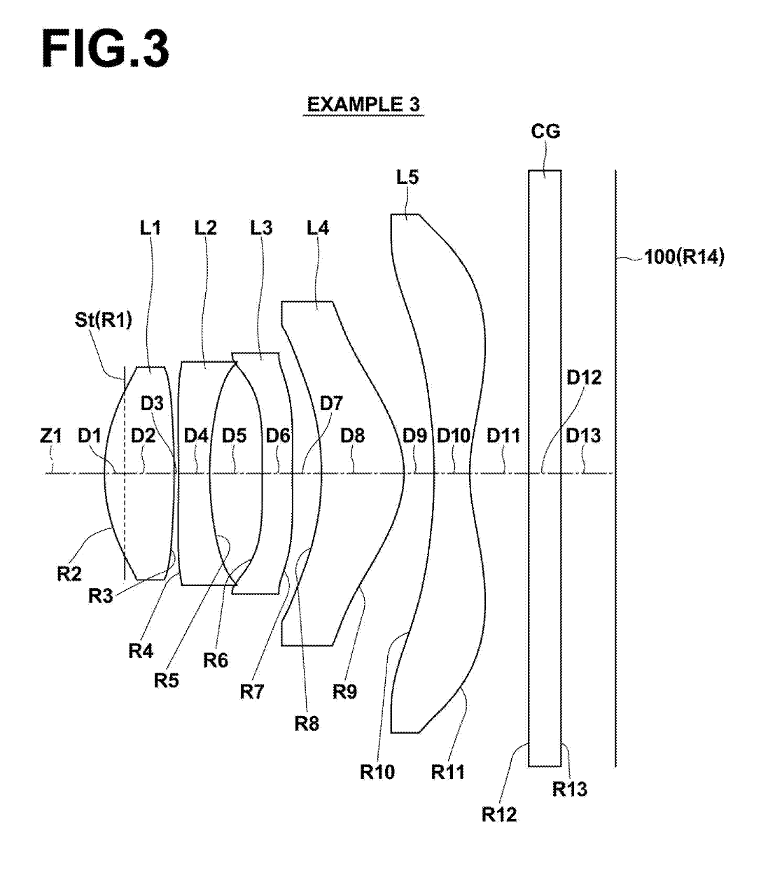

The lens configurations of the first lens L1 through the fifth lens L5 of the imaging lens of Example 2 illustrated in FIG. 2 and the imaging lens of Example 3 illustrated in FIG. 3 are the same as those of Example 1. The same operational effects corresponding to each of the lens configurations as those obtained by Example 1 are obtained by the imaging lenses of Example 2 and Example 3.

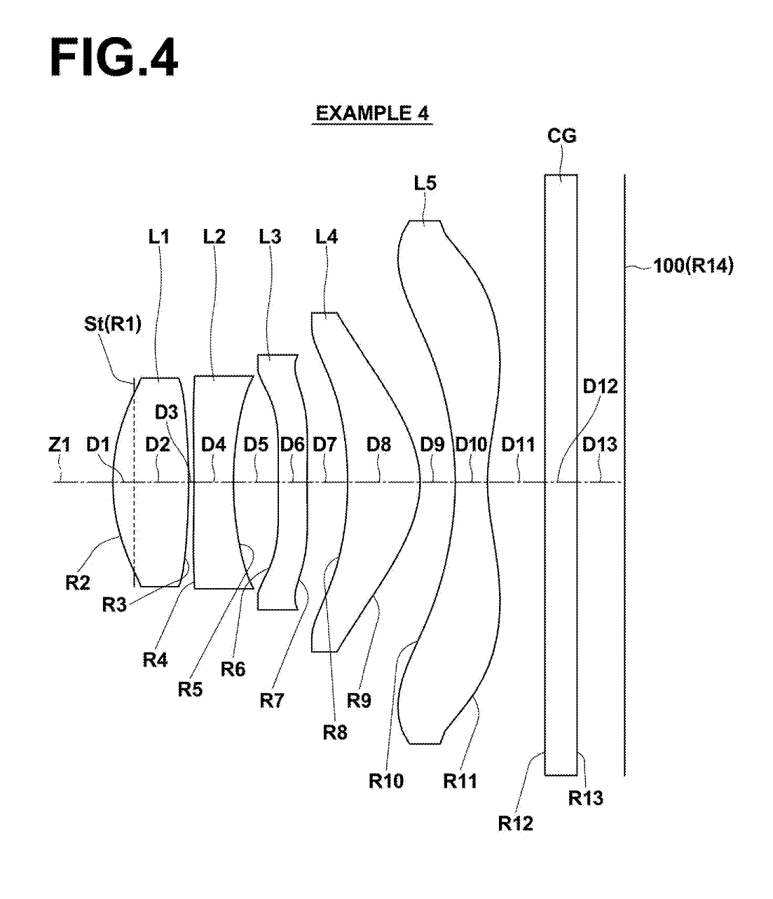

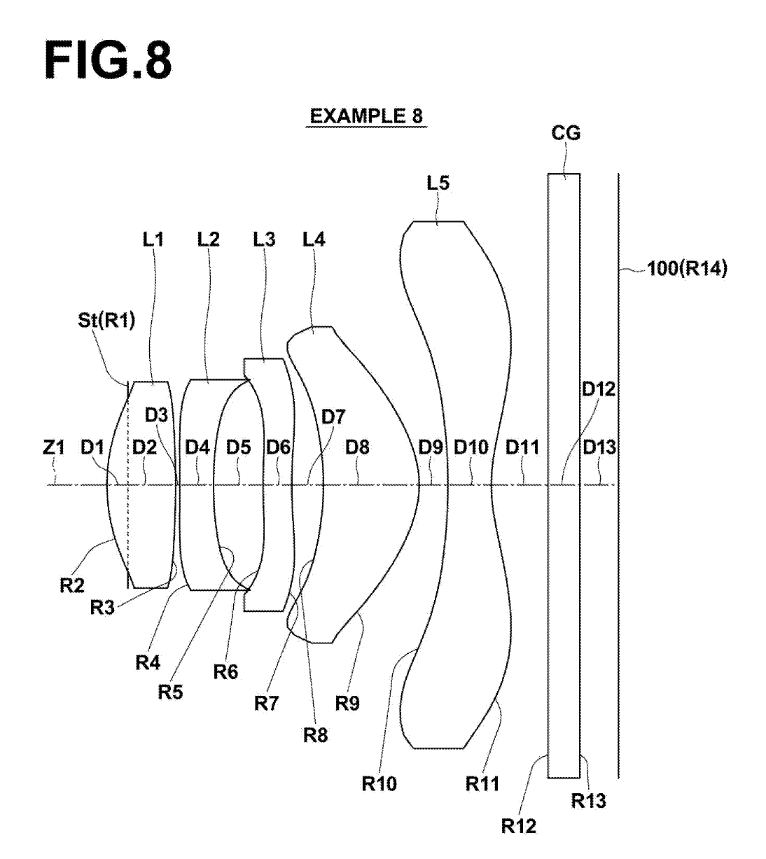

The third lens L3 may be configured to have a negative refractive power in the vicinity of the optical axis and to be of a meniscus shape having a concave surface toward the image side in the vicinity of the optical axis, as in Example 4 through Example 6 illustrated in FIG. 4 through FIG. 6 and Example 8 illustrated in FIG. 8. In the case that the third lens L3 is configured to be of a meniscus shape having a concave surface toward the image side in the vicinity of the optical axis, the negative refractive power of the third lens L3 will enable spherical aberration and chromatic aberration to be favorably corrected, while the convex surface shape toward the object side of the meniscus shape of the third lens L3 will enable the total length to be favorably shortened. The lens configurations of the first lens L1, the second lens L2, the fourth lens L4, and the fifth lens L5 of the imaging lenses of Example 4 through Example 6 and Example 8 are the same as those of Example 1. The same operational effects corresponding to each of the lens configurations as those obtained by Example 1 are obtained by the imaging lenses of Example 4 through Example 8. In addition, the lens configurations of the lenses of Reference Example 7 illustrated in FIG. 7 are the same as those of in Example 4 through Example 6 and Example 8. The same operational effects corresponding to each of the lens configurations as those obtained by Example 4 through Example 6 and Example 8 are obtained by the imaging lens of Reference Example 7 illustrated in FIG. 7.

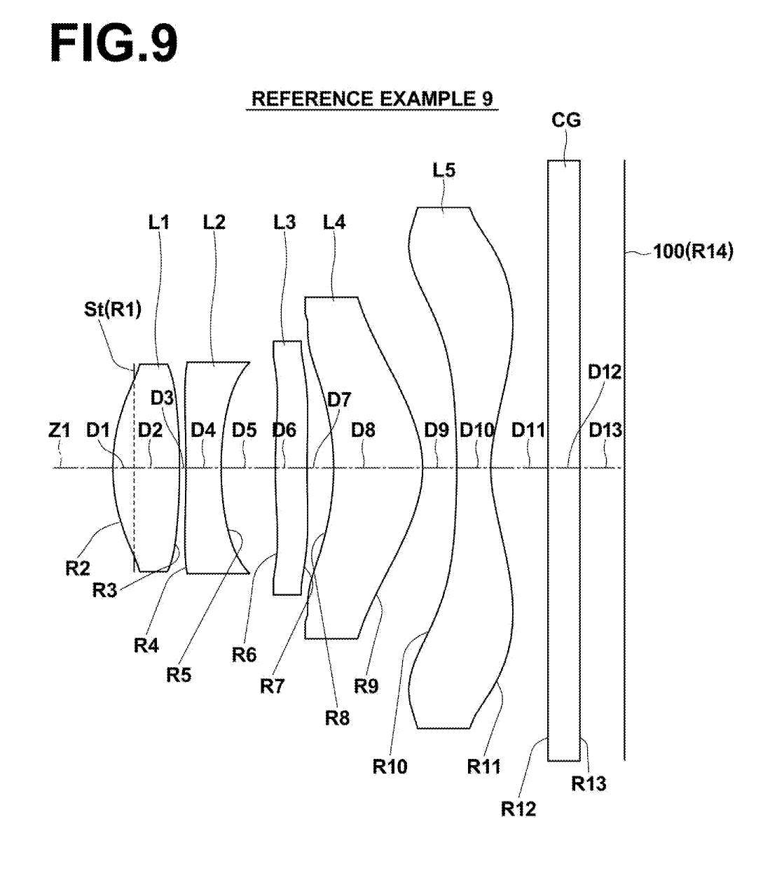

In addition, the third lens L3 may have a positive refractive power in the vicinity of the optical axis and be of a meniscus shape having a concave surface toward the image side in the vicinity of the optical axis, as in Reference Example 9 through Reference Example 11 illustrated in FIG. 9 through FIG. 11. In the case that the third lens L3 has a positive refractive power in the vicinity of the optical axis, the positive refractive power of the third lens L3 will enable the total length to be favorably shortened. In addition, the third lens L3 is configured to have a positive refractive power in the vicinity of the optical axis and to be of a meniscus shape in the vicinity of the optical axis. Therefore, the positive refractive power of the third lens L3 will enable the total length to be favorably shortened, while the concave surface shape toward the image side of the meniscus shape of the third lens L3 will enable spherical aberration and chromatic aberration to be favorably corrected. The lens configurations of the first lens L1, the second lens L2, the fourth lens L4, and the fifth lens L5 of the imaging lenses of Reference Example 9 through Reference Example 11 are the same as those of Example 1. The same operational effects corresponding to each of the lens configurations as those obtained by Example 1 are obtained by the imaging lenses of Reference Example 9 through Reference Example 11.

As described above, in the imaging lenses L of the Examples of the present invention, the configuration of each lens element is optimized within a lens configuration having fifth lenses as a whole. Therefore, a lens system that has a small F number, a short total length, a large image size, and high resolution performance can be realized.

Note that in contrast, Chinese Utility Model Publication No. 201903684 discloses an imaging lens having a large F number, or an imaging lens having a comparatively small F number but is not capable of sufficiently correcting spherical aberration. The imaging lens disclosed in International Patent Publication No. 2011/118554 has a large F number, and does not sufficiently correct spherical aberration. The lens disclosed in Japanese Unexamined Patent Publication No. 2010-152042 does not sufficiently correct longitudinal chromatic aberration or spherical aberration, and therefore it cannot be said that this imaging lens has sufficiently high resolution performance. In addition, the imaging lens disclosed in U.S. Pat. No. 8,305,697 does not realize a sufficient shortening of the total length to meet the specifications required in portable terminals, smart phones, tablet type terminals, and the like. Therefore, a further shortening of the total length is required.

Further improved imaging performance can be realized by appropriately satisfying preferred conditions. In addition, the imaging apparatuses according to the embodiments of the present invention output image signals corresponding to optical images formed by the high performance imaging lenses L according to the embodiments of the present invention. Therefore, photographed images having high resolution from a central angle of view to peripheral angles of view can be obtained.

Next, specific examples of numerical values of the imaging lens of the present invention will be described. A plurality of examples of numerical values will be summarized and explained below.

Table 1 and Table 2 below show specific lens data corresponding to the configuration of the imaging lens illustrated in FIG. 1. Specifically, Table 1 shows basic lens data of the imaging lens, and Table 2 shows data related to aspherical surfaces. In the lens data of Table 1, ith numbers of the surfaces of lens elements that sequentially increase from the object side to the image side, with the lens element at the most object side designated as first (the aperture stop St is first), are shown in the column Si for the imaging lens of Example 1. The radii of curvature (mm) of ith surfaces from the object side corresponding to the symbols Ri illustrated in FIG. 1 are shown in the column Ri. Similarly, the distances (mm) between an ith surface Si and an i+1st surface Si+1 from the object side along the optical axis are shown in the column Di. The refractive indices of jth optical elements from the object side with respect to the d line (wavelength: 587.56 nm) are shown in the column Ndj. The Abbe's numbers of the jth optical elements with respect to the d line are shown in the column νdj. In addition, Table 1 also shows the focal length f (mm) of the entire system and the back focus Bf (mm) as various data. Note that the back focus Bf is represented as an air converted value.

In the imaging lens of Example 1, both of the surfaces of all of the first lens L1 through the fifth lens L5 are aspherical in shape. In the basic lens data of Table 1, numerical values of radii of curvature in the vicinity of the optical axis (paraxial radii of curvature) are shown as the radii of curvature of the aspherical surfaces.

Table 2 shows aspherical surface data of the imaging lens of Example 1. In the numerical values shown as the aspherical surface data, the symbol “E” indicates that the numerical value following thereafter is a “power index” having 10 as a base, and that the numerical value represented by the index function having 10 as a base is to be multiplied by the numerical value in front of “E”. For example, “1.0E-02” indicates that the numerical value is “1.0·10⁻²”.

The values of coefficients Ai and KA represented by the aspherical surface shape formula (A) below are shown as the aspherical surface data. In greater detail, Z is the length (mm) of a normal line that extends from a point on the aspherical surface having a height h to a plane (a plane perpendicular to the optical axis) that contacts the apex of the aspherical surface.

Z=c·h²/{1+(1·KA·C²·h²)^{1/2}}+ΣAi·hⁱ (A)

wherein: Z is the depth of the aspherical surface (mm), h is the distance from the optical axis to the surface of the lens (height) (mm), C is the paraxial curvature=1/R (R is the paraxial radius of curvature), Ai is an ith ordinal aspherical surface coefficient (i is an integer 3 or greater), and KA is an aspherical surface coefficient.

Detailed lens data corresponding to the configuration of the imaging lens illustrated in FIG. 2 are shown in Table 3 and Table 4 as Example 2, in the same manner as that for Example 1. Similarly, detailed lens data corresponding to the configurations of the imaging lenses illustrated in FIG. 3 through FIG. 6 and FIG. 8 are shown in Table 5 through Table 12, Table 15 and Table 16 as Example 3 through Example 6 and Example 8. Similarly, lens data of the imaging lenses of the Reference Examples illustrated in FIG. 7 and FIGS. 9 through 11 are shown in Tables 13, 14 and Tables 17 through 22. In the imaging lenses of Examples 1 through 6, Example 8, Reference Example 7, and Reference Examples 9 through 11, both of the surfaces of all of the first lens L1 through the fifth lens L5 are aspherical surfaces.

A through D of FIG. 13 are diagrams that illustrate aberrations of the imaging lens of Example 1, wherein the diagrams respectively illustrate spherical aberration, astigmatism, distortion, and lateral chromatic aberration (chromatic aberration of magnification) of the imaging lens of Example 1. Each of the diagrams that illustrate spherical aberration, astigmatism (field curvature), and distortion illustrate aberrations using the d line (wavelength: 587.56 nm) as a reference wavelength. The diagrams that illustrate spherical aberration and lateral chromatic aberration also show aberrations related to the F line (wavelength: 486.1 nm) and the C line (wavelength: 656.27 nm). In addition, the diagram that illustrates spherical aberration also shows aberration related to the g line (wavelength: 435.83 nm). In the diagram that illustrates astigmatism, aberration in the sagittal direction (S) is indicated by a solid line, while aberration in the tangential direction (T) is indicated by a broken line. In addition, “Fno.” denotes an F number, and “ω” denotes a half angle of view.

Similarly, various aberrations of the imaging lens of Example 2 through Example 6 and Example 8 are illustrated in A through D of FIG. 14 through A through D of FIG. 18 and A through D of FIG. 20. Similarly, various aberrations of the imaging lenses of Reference Example 7 and Reference Examples 9 through 11 are illustrated in A through D of FIG. 19 and A through D of FIG. 21 through A through D of FIG. 23.

Table 23 shows values corresponding to Conditional Formulae (1) through (6), respectively summarized for each of Examples 1 through 6, Example 8, Reference Example 7 and Reference Examples 9 through 11.

As can be understood from each set of numerical value data and from the diagrams that illustrate aberrations, each of the Examples realize a shortening of the total length and high imaging performance.

Note that the imaging lens of the present invention is not limited to the embodiments and Examples described above, and various modifications are possible. For example, the values of the radii of curvature, the distances among surfaces, the refractive indices, the Abbe's numbers, the aspherical surface coefficients, etc., are not limited to the numerical values indicated in connection with the Examples of numerical values, and may be other values.

In addition, the Examples are described under the presumption that they are to be utilized with fixed focus. However, it is also possible for configurations capable of adjusting focus to be adopted. It is possible to adopt a configuration, in which the entirety of the lens system is fed out or a portion of the lenses is moved along the optical axis to enable automatic focus, for example. In addition, each of the lenses which are of meniscus shapes in the vicinity of the optical axis in the imaging lens of the present invention may be configured such that the surface of the meniscus shape having a radius of curvature with the greater absolute value in the vicinity of the optical axis is a planar surface in the vicinity of the optical axis. In other words, the lenses which are of meniscus shapes in the vicinity of the optical axis may be planoconvex lenses or planoconcave lenses, in which the surface of the meniscus shape having a radius of curvature with the greater absolute value is a planar surface in the vicinity of the optical axis.

TABLE 1
Example 1
f = 4.09, Bf = 1.39

| Si | Ri | Di | Ndj | νdj |
|---|---|---|---|---|
| 1 (aperture stop) | ∞ | −0.19 | | |
| *2 | 1.5767 | 0.69 | 1.54488 | 54.87 |
| *3 | −10.0326 | 0.04 | | |
| *4 | −71.6139 | 0.28 | 1.63351 | 23.63 |
| *5 | 2.9569 | 0.47 | | |
| *6 | −36.6830 | 0.28 | 1.63351 | 23.63 |
| *7 | 18.1979 | 0.29 | | |
| *8 | −2.7404 | 0.70 | 1.54488 | 54.87 |
| *9 | −0.8545 | 0.28 | | |
| *10 | −6.1122 | 0.33 | 1.54488 | 54.87 |
| *11 | 1.3765 | 0.55 | | |
| 12 | ∞ | 0.30 | 1.56700 | 37.80 |
| 13 | ∞ | 0.65 | | |
| 14 (imaging surface) | ∞ | | | |

*aspherical surface

TABLE 2
Example 1: Aspherical Surface Data

| Surface | | | | | |
|---|---|---|---|---|---|
| Number | KA | A3 | A4 | A5 | A6 |
| 2 | −1.8153779E−01 | −7.1404067E−02 | 7.2067108E−01 | −5.1685151E+00 | 3.6000577E+01 |
| 3 | −3.3233016E+01 | −1.2280381E−01 | 6.6408794E−01 | −1.1860486E+00 | −1.2578465E+00 |
| 4 | −2.2234972E+03 | −4.7795070E−02 | 9.0230562E−02 | −2.2583156E−01 | 9.2362159E+00 |
| 5 | 2.1407495E−01 | 3.3288434E−02 | −4.7984003E−01 | 2.1525424E+00 | −4.4459987E+00 |
| 6 | −1.0739647E+07 | −8.5233120E−02 | 6.3464752E−01 | −3.7261447E+00 | 7.1292771E+00 |
| 7 | 2.4911217E+01 | 1.2869055E−02 | −5.4310134E−01 | 3.7518458E+00 | −2.4625219E+01 |
| 8 | 5.2154610E−01 | −6.5304653E−02 | 1.3480605E−01 | 5.8343145E−01 | −6.6594269E+00 |
| 9 | −2.0619120E−01 | 1.6803936E−02 | 2.9912011E−01 | −7.4740234E−01 | 4.1991064E+00 |
| 10 | −2.0238715E+00 | −1.0015505E−01 | 4.2139525E−01 | −1.1993178E+00 | 3.1803721E+00 |
| 11 | −3.8847132E−03 | 1.3153101E−02 | −8.9882563E−01 | 1.5867281E+00 | −2.0808025E+00 |
| | A7 | A8 | A9 | A10 | A11 |
| 2 | −2.0909536E+02 | 8.9907530E+02 | −2.7872857E+03 | 6.2918278E+03 | −1.0438288E+04 |
| 3 | 8.5611829E+00 | −9.9314501E+00 | −4.5904119E+00 | 1.2509555E+01 | −1.8259052E+00 |
| 4 | −8.3477517E+01 | 4.0360359E+02 | −1.2737380E+03 | 2.8491243E+03 | −4.6716504E+03 |
| 5 | 1.9341185E+00 | 9.0750940E+00 | −1.5171909E+01 | 4.9528460E+00 | 1.0712650E−02 |
| 6 | −2.8859672E+00 | −1.2921764E+01 | 2.1358780E+01 | −5.1805309E+00 | −8.5781912E+00 |
| 7 | 1.1074907E+02 | −3.5932600E+02 | 8.5583671E+02 | −1.5031476E+03 | 1.9394047E+03 |
| 8 | 2.9526388E+01 | −8.5052336E+01 | 1.7657912E+02 | −2.7055040E+02 | 3.0574486E+02 |
| 9 | −1.7079698E+01 | 4.4001983E+01 | −7.8899434E+01 | 1.0357519E+02 | −1.0055223E+02 |
| 10 | −7.3316230E+00 | 1.3109848E+01 | −1.7401067E+01 | 1.6838287E+01 | −1.1741600E+01 |
| 11 | 3.0348903E+00 | −4.5479302E+00 | 5.4653210E+00 | −4.7977532E+00 | 3.0217643E+00 |
| | A12 | A13 | A14 | A15 | A16 |
| 2 | 1.2664582E+04 | −1.0950310E+04 | 6.3801225E+03 | −2.2376347E+03 | 3.5552478E+02 |
| 3 | 1.2018321E+01 | −4.7122129E+01 | 5.2028391E+01 | −2.3112542E+01 | 3.3072256E+00 |
| 4 | 5.6165812E+03 | −4.8167974E+03 | 2.7792157E+03 | −9.6211932E+02 | 1.5022071E+02 |
| 5 | 1.3114018E+01 | −1.4341665E+01 | −4.3903303E+00 | 1.2289409E+01 | −4.6789843E+00 |
| 6 | −8.0505442E+00 | 2.6216251E+01 | −1.8462796E+01 | 4.2922028E+00 | 5.8557080E−02 |
| 7 | −1.8119022E+03 | 1.1900931E+03 | −5.2008342E+02 | 1.3554719E+02 | −1.5922029E+01 |
| 8 | −2.5201447E+02 | 1.4805278E+02 | −5.9085497E+01 | 1.4410778E+01 | −1.6200871E+00 |
| 9 | 7.1163443E+01 | −3.5515176E+01 | 1.1787685E+01 | −2.3271922E+00 | 2.0640539E−01 |
| 10 | 5.8126375E+00 | −1.9877493E+00 | 4.4566424E−01 | −5.8878746E−02 | 3.4728633E−03 |
| 11 | −1.3530278E+00 | 4.2135364E−01 | −8.6912872E−02 | 1.0682763E−02 | −5.9134252E−04 |

TABLE 3
Example 2
f = 4.11, Bf = 1.35

| Si | Ri | Di | Ndj | νdj |
|---|---|---|---|---|
| 1 (aperture stop) | ∞ | −0.19 | | |
| *2 | 1.5799 | 0.72 | 1.54488 | 54.87 |
| *3 | −8.5824 | 0.04 | | |
| *4 | −25.1221 | 0.28 | 1.63351 | 23.63 |
| *5 | 3.1198 | 0.47 | | |
| *6 | −29.2525 | 0.28 | 1.61399 | 25.48 |
| *7 | 15.5587 | 0.28 | | |
| *8 | −2.8630 | 0.70 | 1.54488 | 54.87 |
| *9 | −0.8544 | 0.29 | | |
| *10 | −5.3737 | 0.33 | 1.54488 | 54.87 |
| *11 | 1.3732 | 0.55 | | |
| 12 | ∞ | 0.30 | 1.56700 | 37.80 |
| 13 | ∞ | 0.61 | | |
| 14 (imaging surface) | ∞ | | | |

*aspherical surface

TABLE 4
Example 2: Aspherical Surface Data

| Surface | | | | | |
|---|---|---|---|---|---|
| Number | KA | A3 | A4 | A5 | A6 |
| 2 | −1.8198227E−01 | −7.3178322E−02 | 7.2035094E−01 | −5.1686592E+00 | 3.6000558E+01 |
| 3 | −3.3119747E+01 | −1.2363041E−01 | 6.6409488E−01 | −1.1858885E+00 | −1.2575670E+00 |
| 4 | −2.0505804E+03 | −4.6989641E−02 | 9.0258344E−02 | −2.2569757E−01 | 9.2366623E+00 |
| 5 | 2.1325004E−01 | 3.9156609E−02 | −4.7722363E−01 | 2.1528701E+00 | −4.4471075E+00 |
| 6 | −1.2240232E+07 | −8.6359490E−02 | 6.3225087E−01 | −3.7280886E+00 | 7.1276563E+00 |
| 7 | 2.4240560E+01 | 1.3125678E−02 | −5.4273324E−01 | 3.7520204E+00 | −2.4624989E+01 |
| 8 | 5.2099016E−01 | −6.3540109E−02 | 1.3523162E−01 | 5.8388778E−01 | −6.6594434E+00 |
| 9 | −2.0696542E−01 | 1.3609568E−02 | 2.9841765E−01 | −7.4820171E−01 | 4.1985737E+00 |
| 10 | −2.0029424E+00 | −1.0064215E−01 | 4.2089876E−01 | −1.1995092E+00 | 3.1803432E+00 |
| 11 | −3.1005302E−03 | 1.1572359E−02 | −8.9816165E−01 | 1.5867559E+00 | −2.0808617E+00 |
| | A7 | A8 | A9 | A10 | A11 |
| 2 | −2.0909540E+02 | 8.9907523E+02 | −2.7872858E+03 | 6.2918278E+03 | −1.0438288E+04 |
| 3 | 8.5614937E+00 | −9.9309902E+00 | −4.5896819E+00 | 1.2510536E+01 | −1.8246681E+00 |
| 4 | −8.3476987E+01 | 4.0360415E+02 | −1.2737374E+03 | 2.8491244E+03 | −4.6716507E+03 |
| 5 | 1.9320889E+00 | 9.0728500E+00 | −1.5174399E+01 | 4.9510949E+00 | 9.5822249E−03 |
| 6 | −2.8873078E+00 | −1.2922714E+01 | 2.1357855E+01 | −5.1814960E+00 | −8.5792959E+00 |
| 7 | 1.1074931E+02 | −3.5932574E+02 | 8.5583693E+02 | −1.5031474E+03 | 1.9394049E+03 |
| 8 | 2.9526416E+01 | −8.5052442E+01 | 1.7657900E+02 | −2.7055067E+02 | 3.0574475E+02 |
| 9 | −1.7080025E+01 | 4.4001811E+01 | −7.8899524E+01 | 1.0357513E+02 | −1.0055226E+02 |
| 10 | −7.3316419E+00 | 1.3109840E+01 | −1.7401071E+01 | 1.6838286E+01 | −1.1741599E+01 |
| 11 | 3.0348706E+00 | −4.5479395E+00 | 5.4653157E+00 | −4.7977535E+00 | 3.0217648E+00 |
| | A12 | A13 | A14 | A15 | A16 |
| 2 | 1.2664582E+04 | −1.0950309E+04 | 6.3801231E+03 | −2.2376335E+03 | 3.5552636E+02 |
| 3 | 1.2019762E+01 | −4.7120707E+01 | 5.2029549E+01 | −2.3112117E+01 | 3.3065236E+00 |
| 4 | 5.6165808E+03 | −4.8167975E+03 | 2.7792160E+03 | −9.6211793E+02 | 1.5022385E+02 |
| 5 | 1.3114056E+01 | −1.4342143E+01 | −4.3898044E+00 | 1.2290332E+01 | −4.6802531E+00 |
| 6 | −8.0523621E+00 | 2.6214584E+01 | −1.8464453E+01 | 4.2903354E+00 | 5.7060848E−02 |
| 7 | −1.8119021E+03 | 1.1900931E+03 | −5.2008360E+02 | 1.3554689E+02 | −1.5922511E+01 |
| 8 | −2.5201458E+02 | 1.4805277E+02 | −5.9085495E+01 | 1.4410782E+01 | −1.6200388E+00 |
| 9 | 7.1163426E+01 | −3.5515193E+01 | 1.1787674E+01 | −2.3272003E+00 | 2.0639843E−01 |
| 10 | 5.8126380E+00 | −1.9877491E+00 | 4.4566396E−01 | −5.8878611E−02 | 3.4729544E−03 |
| 11 | −1.3530274E+00 | 4.2135380E−01 | −8.6912930E−02 | 1.0682825E−02 | −5.9131896E−04 |

TABLE 5
Example 3
f = 4.10, Bf = 1.25

| Si | Ri | Di | Ndj | νdj |
|---|---|---|---|---|
| 1 (aperture stop) | ∞ | −0.19 | | |
| *2 | 1.4808 | 0.65 | 1.54488 | 54.87 |
| *3 | −6.5812 | 0.04 | | |
| *4 | −21.1349 | 0.29 | 1.63351 | 23.63 |
| *5 | 2.8091 | 0.49 | | |
| *6 | −24.8812 | 0.28 | 1.63351 | 23.63 |
| *7 | 17.4572 | 0.27 | | |
| *8 | −2.5831 | 0.77 | 1.54488 | 54.87 |
| *9 | −0.8618 | 0.28 | | |
| *10 | −4.9506 | 0.33 | 1.54488 | 54.87 |
| *11 | 1.4011 | 0.55 | | |
| 12 | ∞ | 0.30 | 1.56700 | 37.80 |
| 13 | ∞ | 0.51 | | |
| 14 (imaging surface) | ∞ | | | |

*aspherical surface

TABLE 6
Example 3: Aspherical Surface Data

| Surface | | | | | |
|---|---|---|---|---|---|
| Number | KA | A3 | A4 | A5 | A6 |
| 2 | −1.7432177E−01 | −7.3243484E−02 | 7.2452229E−01 | −5.1659619E+00 | 3.6001482E+01 |
| 3 | −3.3214797E+01 | −1.1677511E−01 | 6.6592195E−01 | −1.1859915E+00 | −1.2587164E+00 |
| 4 | −2.2189653E+03 | −4.8022188E−02 | 9.2387185E−02 | −2.2354561E−01 | 9.2389550E+00 |
| 5 | 2.0632323E−01 | 3.8697400E−02 | −4.7852630E−01 | 2.1530981E+00 | −4.4454896E+00 |
| 6 | −4.6311720E+06 | −8.3381706E−02 | 6.3432835E−01 | −3.7299105E+00 | 7.1235158E+00 |
| 7 | 2.2014564E+01 | 1.3299100E−02 | −5.4191681E−01 | 3.7526809E+00 | −2.4624790E+01 |
| 8 | 5.2536955E−01 | −6.9954390E−02 | 1.3228056E−01 | 5.8371684E−01 | −6.6580825E+00 |
| 9 | −2.2596529E−01 | 1.5340488E−02 | 3.0090457E−01 | −7.4743302E−01 | 4.1985851E+00 |
| 10 | −2.0210605E+00 | −9.9625548E−02 | 4.2131019E−01 | −1.1993066E+00 | 3.1803040E+00 |
| 11 | −4.5933125E−03 | 8.7304687E−03 | −8.9852143E−01 | 1.5863788E+00 | −2.0810430E+00 |
| | A7 | A8 | A9 | A10 | A11 |
| 2 | −2.0909596E+02 | 8.9907384E+02 | −2.7872875E+03 | 6.2918259E+03 | −1.0438290E+04 |
| 3 | 8.5595550E+00 | −9.9334296E+00 | −4.5923218E+00 | 1.2507671E+01 | −1.8272977E+00 |
| 4 | −8.3475194E+01 | 4.0360553E+02 | −1.2737374E+03 | 2.8491252E+03 | −4.6716501E+03 |
| 5 | 1.9348895E+00 | 9.0757777E+00 | −1.5171031E+01 | 4.9551539E+00 | 1.4039931E−02 |
| 6 | −2.8920172E+00 | −1.2926584E+01 | 2.1354138E+01 | −5.1844928E+00 | −8.5821213E+00 |
| 7 | 1.1074926E+02 | −3.5932596E+02 | 8.5583665E+02 | −1.5031475E+03 | 1.9394050E+03 |
| 8 | 2.9527741E+01 | −8.5051633E+01 | 1.7657936E+02 | −2.7055073E+02 | 3.0574448E+02 |
| 9 | −1.7080185E+01 | 4.4001719E+01 | −7.8899581E+01 | 1.0357509E+02 | −1.0055227E+02 |
| 10 | −7.3316259E+00 | 1.3109843E+01 | −1.7401073E+01 | 1.6838286E+01 | −1.1741600E+01 |
| 11 | 3.0348048E+00 | −4.5479590E+00 | 5.4653164E+00 | −4.7977529E+00 | 3.0217653E+00 |
| | A12 | A13 | A14 | A15 | A16 |
| 2 | 1.2664581E+04 | −1.0950311E+04 | 6.3801203E+03 | −2.2376375E+03 | 3.5552117E+02 |
| 3 | 1.2017749E+01 | −4.7121721E+01 | 5.2029139E+01 | −2.3110905E+01 | 3.3083456E+00 |
| 4 | 5.6165814E+03 | −4.8167960E+03 | 2.7792173E+03 | −9.6211516E+02 | 1.5022922E+02 |
| 5 | 1.3114789E+01 | −1.4335300E+01 | −4.3876036E+00 | 1.2290421E+01 | −4.6829963E+00 |
| 6 | −8.0549254E+00 | 2.6213452E+01 | −1.8468237E+01 | 4.2853644E+00 | 5.2352120E−02 |
| 7 | −1.8119020E+03 | 1.1900935E+03 | −5.2008348E+02 | 1.3554725E+02 | −1.5922309E+01 |
| 8 | −2.5201496E+02 | 1.4805237E+02 | −5.9085853E+01 | 1.4410491E+01 | −1.6201541E+00 |
| 9 | 7.1163417E+01 | −3.5515200E+01 | 1.1787671E+01 | −2.3272059E+00 | 2.0639213E−01 |
| 10 | 5.8126374E+00 | −1.9877493E+00 | 4.4566407E−01 | −5.8878679E−02 | 3.4729126E−03 |
| 11 | −1.3530272E+00 | 4.2135393E−01 | −8.6912864E−02 | 1.0682805E−02 | −5.9133229E−04 |

TABLE 7
Example 4
f = 4.11, Bf = 1.18

| Si | Ri | Di | Ndj | νdj |
|---|---|---|---|---|
| 1 (aperture stop) | ∞ | −0.20 | | |
| *2 | 1.6219 | 0.71 | 1.54488 | 54.87 |
| *3 | −6.6284 | 0.05 | | |
| *4 | −21.1980 | 0.37 | 1.63351 | 23.63 |
| *5 | 2.7636 | 0.42 | | |
| *6 | 13.4840 | 0.27 | 1.63351 | 23.63 |
| *7 | 8.3921 | 0.38 | | |
| *8 | −3.3269 | 0.68 | 1.54488 | 54.87 |
| *9 | −0.8840 | 0.33 | | |
| *10 | −2.9411 | 0.30 | 1.54488 | 54.87 |
| *11 | 1.5542 | 0.54 | | |
| 12 | ∞ | 0.30 | 1.56700 | 37.80 |
| 13 | ∞ | 0.45 | | |
| 14 (imaging surface) | ∞ | | | |

*aspherical surface

TABLE 8
Example 4: Aspherical Surface Data

| Surface | | | | | |
|---|---|---|---|---|---|
| Number | KA | A3 | A4 | A5 | A6 |
| 2 | −1.4359234E−01 | −6.4062935E−02 | 7.0274848E−01 | −5.3810331E+00 | 3.8412758E+01 |
| 3 | −2.6303656E+01 | −1.1644915E−01 | 6.7601124E−01 | −1.3664230E+00 | −1.2031072E+00 |
| 4 | −1.8765525E+03 | −2.5223718E−02 | 2.5674573E−02 | −2.2774434E−01 | 9.8845702E+00 |
| 5 | −6.0072677E−01 | 2.8156189E−02 | −4.6046879E−01 | 2.1971314E+00 | −4.8207859E+00 |
| 6 | −2.0631737E+04 | 3.7637534E−02 | 3.4505057E−01 | −3.6216654E+00 | 7.6022647E+00 |
| 7 | −2.7614103E+01 | −1.2940582E−02 | −5.3845564E−01 | 3.9164570E+00 | −2.6284565E+01 |
| 8 | −1.0610086E−01 | −6.5465366E−02 | 1.3436793E−01 | 6.1706266E−01 | −7.1265084E+00 |
| 9 | −3.9095442E−01 | −1.7934825E−02 | 3.1549425E−01 | −7.9963134E−01 | 4.4732842E+00 |
| 10 | −1.9563225E+00 | −9.4955201E−02 | 4.3175422E−01 | −1.2668531E+00 | 3.3980274E+00 |
| 11 | −3.8367331E−02 | 3.1011678E−02 | −9.3813725E−01 | 1.6730395E+00 | −2.2236697E+00 |
| | A7 | A8 | A9 | A10 | A11 |
| 2 | −2.2623482E+02 | 9.8519303E+02 | −3.0944004E+03 | 7.0773817E+03 | −1.1896028E+04 |
| 3 | 9.3781003E+00 | −1.0901634E+01 | −5.2581061E+00 | 1.3958698E+01 | −2.0337738E+00 |
| 4 | −9.0251617E+01 | 4.4236596E+02 | −1.4141774E+03 | 3.2047444E+03 | −5.3241262E+03 |
| 5 | 2.3274469E+00 | 9.8899870E+00 | −1.6924429E+01 | 5.5442480E+00 | 6.1955188E−02 |
| 6 | −3.2649549E+00 | −1.4249908E+01 | 2.3765622E+01 | −5.7359917E+00 | −9.6617270E+00 |
| 7 | 1.1980687E+02 | −3.9374759E+02 | 9.5016763E+02 | −1.6908307E+03 | 2.2102211E+03 |
| 8 | 3.1923503E+01 | −9.3205857E+01 | 1.9604239E+02 | −3.0432497E+02 | 3.4844575E+02 |
| 9 | −1.8473561E+01 | 4.8219376E+01 | −8.7597152E+01 | 1.1650550E+02 | −1.1459408E+02 |
| 10 | −7.9297528E+00 | 1.4366146E+01 | −1.9319276E+01 | 1.8940522E+01 | −1.3381327E+01 |
| 11 | 3.2831338E+00 | −4.9836055E+00 | 6.0678284E+00 | −5.3967474E+00 | 3.4437534E+00 |
| | A12 | A13 | A14 | A15 | A16 |
| 2 | 1.4622954E+04 | −1.2810065E+04 | 7.5619374E+03 | −2.6868943E+03 | 4.3247304E+02 |
| 3 | 1.3970215E+01 | −5.5042208E+01 | 6.1678331E+01 | −2.7840810E+01 | 4.0379446E+00 |
| 4 | 6.4851318E+03 | −5.6349073E+03 | 3.2941329E+03 | −1.1552482E+03 | 1.8269694E+02 |
| 5 | 1.5113372E+01 | −1.6837442E+01 | −5.1404867E+00 | 1.4749656E+01 | −5.6956100E+00 |
| 6 | −9.3955898E+00 | 3.0747953E+01 | −2.1818132E+01 | 5.1348085E+00 | −8.2417900E−02 |
| 7 | −2.0920816E+03 | 1.3922458E+03 | −6.1639903E+02 | 1.6279131E+02 | −1.9420780E+01 |
| 8 | −2.9098675E+02 | 1.7319790E+02 | −7.0028417E+01 | 1.7304887E+01 | −1.9724652E+00 |
| 9 | 8.2168579E+01 | −4.1547025E+01 | 1.3971018E+01 | −2.7944166E+00 | 2.5108709E−01 |
| 10 | 6.7114823E+00 | −2.3253789E+00 | 5.2826310E−01 | −7.0710003E−02 | 4.2235343E−03 |
| 11 | −1.5622647E+00 | 4.9291620E−01 | −1.0301434E−01 | 1.2828794E−02 | −7.1938808E−04 |

TABLE 9
Example 5
f = 4.11, Bf = 1.18

| Si | Ri | Di | Ndj | νdj |
|---|---|---|---|---|
| 1 | ∞ | −0.20 | | |
| (aperture stop) | | | | |
| *2 | 1.5724 | 0.82 | 1.54488 | 54.87 |
| *3 | −5.8528 | 0.04 | | |
| *4 | −19.0000 | 0.36 | 1.63351 | 23.63 |
| *5 | 2.3947 | 0.45 | | |
| *6 | 6.9091 | 0.27 | 1.63351 | 23.63 |
| *7 | 6.3333 | 0.28 | | |
| *8 | −2.4761 | 0.71 | 1.54488 | 54.87 |
| *9 | −0.8733 | 0.30 | | |
| *10 | −8.5515 | 0.30 | 1.54488 | 54.87 |
| *11 | 1.2689 | 0.54 | | |
| 12 | ∞ | 0.30 | 1.56700 | 37.80 |
| 13 | ∞ | 0.45 | | |
| 14 | ∞ | | | |
| (imaging surface) | | | | |

*aspherical surface

TABLE 10
Example 5: Aspherical Surface Data

| Surface | | | | | |
|---|---|---|---|---|---|
| Number | KA | A3 | A4 | A5 | A6 |
| 2 | −2.0481747E−01 | −6.6982920E−02 | 7.2555519E−01 | −5.4109815E+00 | 3.8433682E+01 |
| 3 | −2.5489766E+01 | −7.6490559E−02 | 5.8921006E−01 | −1.1170759E+00 | −1.3965575E+00 |
| 4 | −5.6728628E+03 | −2.0755844E−02 | 1.2727000E−02 | −1.6639943E−01 | 9.9113012E+00 |
| 5 | 3.2474760E−01 | 4.9823154E−02 | −5.2419378E−01 | 2.3113157E+00 | −4.7025808E+00 |
| 6 | −3.0535047E+03 | 1.5065622E−01 | 2.9029332E−01 | −3.6004519E+00 | 7.6726406E+00 |
| 7 | −1.3959561E+01 | −1.2034177E−02 | −4.9904306E−01 | 3.9210451E+00 | −2.6286301E+01 |
| 8 | −6.8365501E−01 | −8.2937372E−02 | 1.4413104E−01 | 6.4267674E−01 | −7.1351194E+00 |
| 9 | −2.9217538E−01 | 7.7795150E−03 | 3.0938163E−01 | −7.9820917E−01 | 4.4796657E+00 |
| 10 | 9.2341888E−01 | −1.2328097E−01 | 4.2403861E−01 | −1.2514980E+00 | 3.3818258E+00 |
| 11 | −2.2348327E−02 | −2.6603618E−02 | −9.0668612E−01 | 1.6562820E+00 | −2.2199130E+00 |
| | A7 | A8 | A9 | A10 | A11 |
| 2 | −2.2621567E+02 | 9.8523932E+02 | −3.0944964E+03 | 7.0774265E+03 | −1.1896092E+04 |
| 3 | 9.2588693E+00 | −1.0810134E+01 | −5.3017999E+00 | 1.4177764E+01 | −2.0657787E+00 |
| 4 | −9.0289166E+01 | 4.4224824E+02 | −1.4143334E+03 | 3.2048448E+03 | −5.3239499E+03 |
| 5 | 2.0262526E+00 | 1.0011606E+01 | −1.6976935E+01 | 5.7804137E+00 | −1.3837536E−01 |
| 6 | −3.2719619E+00 | −1.4281863E+01 | 2.3713605E+01 | −5.6953844E+00 | −9.6264655E+00 |
| 7 | 1.1978856E+02 | −3.9375352E+02 | 9.5016775E+02 | −1.6908152E+03 | 2.2102262E+03 |
| 8 | 3.1930354E+01 | −9.3203808E+01 | 1.9605226E+02 | −3.0432863E+02 | 3.4844270E+02 |
| 9 | −1.8475179E+01 | 4.8216755E+01 | −8.7598275E+01 | 1.1650632E+02 | −1.1459355E+02 |
| 10 | −7.9272549E+00 | 1.4367551E+01 | −1.9319462E+01 | 1.8940644E+01 | −1.3381367E+01 |
| 11 | 3.2837743E+00 | −4.9834233E+00 | 6.0674275E+00 | −5.3967562E+00 | 3.4437829E+00 |
| | A12 | A13 | A14 | A15 | A16 |
| 2 | 1.4623015E+04 | −1.2810067E+04 | 7.5619653E+03 | −2.6868868E+03 | 4.3244755E+02 |
| 3 | 1.3835512E+01 | −5.4913711E+01 | 6.1497287E+01 | −2.7813531E+01 | 4.0985090E+00 |
| 4 | 6.4853375E+03 | −5.6348840E+03 | 3.2938429E+03 | −1.1555293E+03 | 1.8298044E+02 |
| 5 | 1.5234647E+01 | −1.6867285E+01 | −5.0895139E+00 | 1.4565761E+01 | −5.5950042E+00 |
| 6 | −9.3440113E+00 | 3.0595761E+01 | −2.1939147E+01 | 5.0689409E+00 | 1.1218574E−01 |
| 7 | −2.0920963E+03 | 1.3922219E+03 | −6.1642411E+02 | 1.6277207E+02 | −1.9380234E+01 |
| 8 | −2.9098949E+02 | 1.7319882E+02 | −7.0030659E+01 | 1.7308038E+01 | −1.9733761E+00 |
| 9 | 8.2169253E+01 | −4.1547572E+01 | 1.3970387E+01 | −2.7942480E+00 | 2.5125013E−01 |
| 10 | 6.7114843E+00 | −2.3253591E+00 | 5.2825200E−01 | −7.0712495E−02 | 4.2248075E−03 |
| 11 | −1.5622215E+00 | 4.9289311E−01 | −1.0301198E−01 | 1.2829748E−02 | −7.1966546E−04 |

TABLE 11
Example 6
f = 4.15, Bf = 1.21

| Si | Ri | Di | Ndj | νdj |
|---|---|---|---|---|
| 1 | ∞ | −0.20 | | |
| (aperture stop) | | | | |
| *2 | 1.6444 | 0.72 | 1.54488 | 54.87 |
| *3 | −8.5760 | 0.04 | | |
| *4 | −74.0411 | 0.38 | 1.63351 | 23.63 |
| *5 | 2.7636 | 0.50 | | |
| *6 | 11.0781 | 0.30 | 1.63351 | 23.63 |
| *7 | 6.3008 | 0.27 | | |
| *8 | −3.3235 | 0.80 | 1.54488 | 54.87 |
| *9 | −0.9199 | 0.34 | | |
| *10 | −4.4404 | 0.32 | 1.54488 | 54.87 |
| *11 | 1.5448 | 0.54 | | |
| 12 | ∞ | 0.30 | 1.56700 | 37.80 |
| 13 | ∞ | 0.47 | | |
| 14 | ∞ | | | |
| (imaging surface) | | | | |

*aspherical surface

TABLE 12
Example 6: Aspherical Surface Data

| Surface | | | | | |
|---|---|---|---|---|---|
| Number | KA | A3 | A4 | A5 | A6 |
| 2 | −2.2860912E−01 | −6.0830529E−02 | 7.1055157E−01 | −5.4093978E+00 | 3.8425498E+01 |
| 3 | −3.9516747E+01 | −1.4556676E−01 | 6.9610220E−01 | −1.2268703E+00 | −1.3323677E+00 |
| 4 | −1.5432619E+04 | −4.6515865E−02 | 6.2391232E−02 | −1.9835805E−01 | 9.8492135E+00 |
| 5 | 2.8110160E−01 | 2.5890090E−02 | −4.6143835E−01 | 2.2152459E+00 | −4.7626781E+00 |
| 6 | −1.6716511E+04 | 3.4049414E−02 | 4.8955102E−01 | −3.8261498E+00 | 7.6469172E+00 |
| 7 | −2.0580723E+01 | −1.6547271E−02 | −4.9789929E−01 | 3.9407390E+00 | −2.6313388E+01 |
| 8 | −1.0318385E−01 | −7.3075323E−02 | 1.3843144E−01 | 6.2695392E−01 | −7.1141282E+00 |
| 9 | −2.4402945E−01 | −3.8313655E−02 | 3.3421059E−01 | −7.8409867E−01 | 4.4675162E+00 |
| 10 | −1.3927933E+00 | −9.7460347E−02 | 4.3693714E−01 | −1.2647101E+00 | 3.3932440E+00 |
| 11 | −4.7611610E−02 | 7.1179415E−02 | −9.3907001E−01 | 1.6411727E+00 | −2.2022046E+00 |
| | A7 | A8 | A9 | A10 | A11 |
| 2 | −2.2617089E+02 | 9.8519803E+02 | −3.0944839E+03 | 7.0773608E+03 | −1.1896046E+04 |
| 3 | 9.2550972E+00 | −1.0881780E+01 | −5.1050311E+00 | 1.4066930E+01 | −2.0796006E+00 |
| 4 | −9.0299492E+01 | 4.4228822E+02 | −1.4141183E+03 | 3.2048384E+03 | −5.3240702E+03 |
| 5 | 2.1082350E+00 | 9.9640544E+00 | −1.6813138E+01 | 5.5887989E+00 | 2.1761378E−03 |
| 6 | −3.1405009E+00 | −1.4210691E+01 | 2.3730454E+01 | −5.8315512E+00 | −9.7602389E+00 |
| 7 | 1.1978717E+02 | −3.9374789E+02 | 9.5017553E+02 | −1.6908089E+03 | 2.2102387E+03 |
| 8 | 3.1931031E+01 | −9.3202375E+01 | 1.9602870E+02 | −3.0432742E+02 | 3.4844195E+02 |
| 9 | −1.8480491E+01 | 4.8221375E+01 | −8.7598536E+01 | 1.1650875E+02 | −1.1459441E+02 |
| 10 | −7.9298815E+00 | 1.4365798E+01 | −1.9318866E+01 | 1.8940505E+01 | −1.3381328E+01 |
| 11 | 3.2796111E+00 | −4.9840782E+00 | 6.0676720E+00 | −5.3967243E+00 | 3.4437707E+00 |
| | A12 | A13 | A14 | A15 | A16 |
| 2 | 1.4623087E+04 | −1.2810082E+04 | 7.5619536E+03 | −2.6870126E+03 | 4.3253926E+02 |
| 3 | 1.3893472E+01 | −5.5141588E+01 | 6.1671706E+01 | −2.7733019E+01 | 4.0120828E+00 |
| 4 | 6.4851261E+03 | −5.6349019E+03 | 3.2939896E+03 | −1.1553393E+03 | 1.8283096E+02 |
| 5 | 1.5125708E+01 | −1.6910731E+01 | −5.1591585E+00 | 1.4768686E+01 | −5.6642207E+00 |
| 6 | −9.3203131E+00 | 3.0678604E+01 | −2.1865450E+01 | 5.1395915E+00 | 3.0618308E−02 |
| 7 | −2.0921047E+03 | 1.3921965E+03 | −6.1640801E+02 | 1.6275821E+02 | −1.9366075E+01 |
| 8 | −2.9097358E+02 | 1.7319637E+02 | −7.0025995E+01 | 1.7291904E+01 | −1.9659010E+00 |
| 9 | 8.2169542E+01 | −4.1548379E+01 | 1.3971276E+01 | −2.7944020E+00 | 2.5108278E−01 |
| 10 | 6.7114853E+00 | −2.3253684E+00 | 5.2825734E−01 | −7.0710398E−02 | 4.2237712E−03 |
| 11 | −1.5622523E+00 | 4.9290389E−01 | −1.0300467E−01 | 1.2827733E−02 | −7.2004073E−04 |

TABLE 13
Reference
Example 7
f = 4.00, Bf = 1.22

| Si | Ri | Di | Ndj | νdj |
|---|---|---|---|---|
| 1 | ∞ | −0.20 | | |
| (aperture stop) | | | | |
| *2 | 1.5395 | 0.67 | 1.54488 | 54.87 |
| *3 | −16.6096 | 0.05 | | |
| *4 | −39.9032 | 0.34 | 1.63351 | 23.63 |
| *5 | 3.1295 | 0.45 | | |
| *6 | 9.7172 | 0.27 | 1.63351 | 23.63 |
| *7 | 5.4389 | 0.29 | | |
| *8 | −3.4492 | 0.79 | 1.54488 | 54.87 |
| *9 | −0.8593 | 0.28 | | |
| *10 | −3.4165 | 0.35 | 1.54488 | 54.87 |
| *11 | 1.5308 | 0.54 | | |
| 12 | ∞ | 0.30 | 1.56700 | 37.80 |
| 13 | ∞ | 0.49 | | |
| 14 | ∞ | | | |
| (imaging surface) | | | | |

*aspherical surface

TABLE 14
Reference Example 7: Aspherical Surface Data

| Surface | | | | | |
|---|---|---|---|---|---|
| Number | KA | A3 | A4 | A5 | A6 |
| 2 | −2.3933713E−01 | −6.1808847E−02 | 7.2396855E−01 | −5.4194642E+00 | 3.8440369E+01 |
| 3 | −1.4815954E+01 | −1.2880749E−01 | 6.2830845E−01 | −1.1856680E+00 | −1.3174643E+00 |
| 4 | −4.7511316E+03 | −4.4733212E−02 | 5.8689273E−02 | −2.5640934E−01 | 9.9147256E+00 |
| 5 | −2.3181708E−01 | 2.3647526E−02 | −4.5164819E−01 | 2.2246203E+00 | −4.7579415E+00 |
| 6 | −1.2197141E+04 | 7.5630497E−02 | 3.4518016E−01 | −3.7380695E+00 | 7.6820679E+00 |
| 7 | −2.0023479E+01 | −6.0062958E−03 | −5.3522330E−01 | 3.9314231E+00 | −2.6295734E+01 |
| 8 | −1.4849689E−01 | −7.1626637E−02 | 1.2624309E−01 | 6.3857351E−01 | −7.1308052E+00 |
| 9 | −4.9845089E−01 | −2.1373313E−02 | 3.0167395E−01 | −8.1273892E−01 | 4.4756007E+00 |
| 10 | −1.5250258E+00 | −6.8957965E−02 | 4.1339675E−01 | −1.2491970E+00 | 3.3859936E+00 |
| 11 | −1.0880225E−01 | 5.3559461E−02 | −9.2900606E−01 | 1.6513391E+00 | −2.2139699E+00 |
| | A7 | A8 | A9 | A10 | A11 |
| 2 | −2.2617182E+02 | 9.8523140E+02 | −3.0945878E+03 | 7.0773900E+03 | −1.1895998E+04 |
| 3 | 9.2813713E+00 | −1.0815240E+01 | −5.3782904E+00 | 1.4169964E+01 | −2.0103062E+00 |
| 4 | −9.0246296E+01 | 4.4232541E+02 | −1.4143113E+03 | 3.2048596E+03 | −5.3240341E+03 |
| 5 | 2.0775063E+00 | 9.9789077E+00 | −1.6923983E+01 | 5.7184489E+00 | 1.9149973E−01 |
| 6 | −3.2151500E+00 | −1.4257804E+01 | 2.3620743E+01 | −5.7327228E+00 | −9.6151071E+00 |
| 7 | 1.1979578E+02 | −3.9374908E+02 | 9.5017292E+02 | −1.6908236E+03 | 2.2102216E+03 |
| 8 | 3.1936009E+01 | −9.3191936E+01 | 1.9605192E+02 | −3.0433806E+02 | 3.4844290E+02 |
| 9 | −1.8470662E+01 | 4.8226205E+01 | −8.7594531E+01 | 1.1650678E+02 | −1.1459498E+02 |
| 10 | −7.9284399E+00 | 1.4367050E+01 | −1.9319585E+01 | 1.8940585E+01 | −1.3381339E+01 |
| 11 | 3.2834082E+00 | −4.9834491E+00 | 6.0670869E+00 | −5.3967203E+00 | 3.4437816E+00 |
| | A12 | A13 | A14 | A15 | A16 |
| 2 | 1.4623126E+04 | −1.2810088E+04 | 7.5618867E+03 | −2.6870290E+03 | 4.3256516E+02 |
| 3 | 1.3910913E+01 | −5.5066445E+01 | 6.1565285E+01 | −2.7748844E+01 | 4.0262472E+00 |
| 4 | 6.4851609E+03 | −5.6348328E+03 | 3.2939635E+03 | −1.1553559E+03 | 1.8281899E+02 |
| 5 | 1.4936657E+01 | −1.7011923E+01 | −5.1913485E+00 | 1.4745223E+01 | −5.4905763E+00 |
| 6 | −9.3715777E+00 | 3.0655735E+01 | −2.1928585E+01 | 5.0443568E+00 | 1.9431535E−01 |
| 7 | −2.0920926E+03 | 1.3922359E+03 | −6.1641509E+02 | 1.6277372E+02 | −1.9387250E+01 |
| 8 | −2.9098551E+02 | 1.7319682E+02 | −7.0032367E+01 | 1.7305607E+01 | −1.9709463E+00 |
| 9 | 8.2168428E+01 | −4.1547518E+01 | 1.3970284E+01 | −2.7948064E+00 | 2.5152743E−01 |
| 10 | 6.7114751E+00 | −2.3253523E+00 | 5.2826003E−01 | −7.0714531E−02 | 4.2243654E−03 |
| 11 | −1.5622180E+00 | 4.9289331E−01 | −1.0300799E−01 | 1.2829363E−02 | −7.2002673E−04 |

TABLE 15
Example 8
f = 4.10, Bf = 1.10

| Si | Ri | Di | Ndj | νdj |
|---|---|---|---|---|
| 1 | ∞ | −0.20 | | |
| (aperture stop) | | | | |
| *2 | 1.5372 | 0.65 | 1.54488 | 54.87 |
| *3 | −9.7165 | 0.04 | | |
| *4 | −37.3021 | 0.32 | 1.63351 | 23.63 |
| *5 | 3.3296 | 0.47 | | |
| *6 | 5.9302 | 0.27 | 1.61399 | 25.48 |
| *7 | 3.6799 | 0.30 | | |
| *8 | −2.5955 | 0.91 | 1.54488 | 54.87 |
| *9 | −0.8776 | 0.27 | | |
| *10 | −6.4158 | 0.41 | 1.54488 | 54.87 |
| *11 | 1.2446 | 0.54 | | |
| 12 | ∞ | 0.30 | 1.56700 | 37.80 |
| 13 | ∞ | 0.37 | | |
| 14 | ∞ | | | |
| (imaging surface) | | | | |

*aspherical surface

TABLE 16
Example 8: Aspherical Surface Data

| Surface | | | | | |
|---|---|---|---|---|---|
| Number | KA | A3 | A4 | A5 | A6 |
| 2 | −2.4823880E−01 | −6.1072275E−02 | 6.8829849E−01 | −5.3267834E+00 | 3.8337856E+01 |
| 3 | −2.4990492E+01 | −9.0673168E−02 | 4.9198224E−01 | −9.7176647E−01 | −1.4549948E+00 |
| 4 | −5.9174067E+04 | −3.9566684E−02 | 2.5901672E−02 | −9.9892307E−02 | 9.9486569E+00 |
| 5 | 5.0321808E−01 | 5.8624021E−02 | −5.0427329E−01 | 2.3281554E+00 | −4.6742534E+00 |
| 6 | −3.2664997E+03 | 1.8552588E−01 | 2.3717068E−01 | −3.6601043E+00 | 7.6799120E+00 |
| 7 | −1.2990610E+01 | 1.1587701E−02 | −4.6400564E−01 | 3.8940629E+00 | −2.6298208E+01 |
| 8 | −6.8778827E−01 | −3.4679436E−02 | 6.3453245E−02 | 7.6070952E−01 | −7.1537158E+00 |
| 9 | −6.8045081E−01 | −4.8241860E−02 | 3.1294856E−01 | −8.2182607E−01 | 4.4812125E+00 |
| 10 | 1.2572225E+00 | −1.2628485E−01 | 4.3700270E−01 | −1.2444641E+00 | 3.3795836E+00 |
| 11 | 1.2475377E−01 | −3.5254118E−02 | −8.9532267E−01 | 1.6526711E+00 | −2.2181146E+00 |
| | A7 | A8 | A9 | A10 | A11 |
| 2 | −2.2630355E+02 | 9.8534883E+02 | −3.0943946E+03 | 7.0773424E+03 | −1.1896096E+04 |
| 3 | 9.2361219E+00 | −1.0813142E+01 | −5.3016986E+00 | 1.4231405E+01 | −1.9596013E+00 |
| 4 | −9.0359465E+01 | 4.4223299E+02 | −1.4142728E+03 | 3.2050686E+03 | −5.3238814E+03 |
| 5 | 2.0805756E+00 | 9.7365212E+00 | −1.6802163E+01 | 5.9894347E+00 | 8.8449543E−02 |
| 6 | −3.2296931E+00 | −1.4227774E+01 | 2.3701221E+01 | −5.7550020E+00 | −9.6774884E+00 |
| 7 | 1.1978876E+02 | −3.9374702E+02 | 9.5017407E+02 | −1.6908112E+03 | 2.2102270E+03 |
| 8 | 3.1856487E+01 | −9.3233279E+01 | 1.9603224E+02 | −3.0431711E+02 | 3.4846275E+02 |
| 9 | −1.8475694E+01 | 4.8212091E+01 | −8.7601389E+01 | 1.1650579E+02 | −1.1459210E+02 |
| 10 | −7.9279227E+00 | 1.4366681E+01 | −1.9319487E+01 | 1.8940606E+01 | −1.3381208E+01 |
| 11 | 3.2826991E+00 | −4.9838129E+00 | 6.0673502E+00 | −5.3967459E+00 | 3.4438057E+00 |
| | A12 | A13 | A14 | A15 | A16 |
| 2 | 1.4622889E+04 | −1.2810196E+04 | 7.5621294E+03 | −2.6866908E+03 | 4.3229278E+02 |
| 3 | 1.3943067E+01 | −5.5363864E+01 | 6.1453220E+01 | −2.7564203E+01 | 4.1142844E+00 |
| 4 | 6.4852439E+03 | −5.6354185E+03 | 3.2940832E+03 | −1.1554656E+03 | 1.8307745E+02 |
| 5 | 1.5264198E+01 | −1.7222350E+01 | −6.3054058E+00 | 1.5912165E+01 | −5.6377117E+00 |
| 6 | −9.3484328E+00 | 3.0719261E+01 | −2.1921592E+01 | 5.0764205E+00 | 2.4729042E−02 |
| 7 | −2.0920977E+03 | 1.3922180E+03 | −6.1643121E+02 | 1.6276963E+02 | −1.9375791E+01 |
| 8 | −2.9096374E+02 | 1.7318446E+02 | −7.0032884E+01 | 1.7309834E+01 | −1.9738312E+00 |
| 9 | 8.2170493E+01 | −4.1547238E+01 | 1.3970844E+01 | −2.7943510E+00 | 2.5114280E−01 |
| 10 | 6.7115161E+00 | −2.3253514E+00 | 5.2821718E−01 | −7.0706647E−02 | 4.2258982E−03 |
| 11 | −1.5622060E+00 | 4.9289671E−01 | −1.0301051E−01 | 1.2829437E−02 | −7.2047653E−04 |

TABLE 17
Reference
Example 9
f = 4.11, Bf = 1.15

| Si | Ri | Di | Ndj | νdj |
|---|---|---|---|---|
| 1 | ∞ | −0.20 | | |
| (aperture stop) | | | | |
| *2 | 1.5691 | 0.63 | 1.54488 | 54.87 |
| *3 | −5.2414 | 0.06 | | |
| *4 | −8.8210 | 0.33 | 1.63351 | 23.63 |
| *5 | 2.7706 | 0.51 | | |
| *6 | 5.6170 | 0.30 | 1.61399 | 25.48 |
| *7 | 11.7399 | 0.25 | | |
| *8 | −2.2139 | 0.84 | 1.54488 | 54.87 |
| *9 | −0.9544 | 0.32 | | |
| *10 | −12.1388 | 0.32 | 1.54488 | 54.87 |
| *11 | 1.2191 | 0.54 | | |
| 12 | ∞ | 0.30 | 1.56700 | 37.80 |
| 13 | ∞ | 0.42 | | |
| 14 | ∞ | | | |
| (imaging surface) | | | | |

aspherical surface

TABLE 18
Reference Example 9: Aspherical Surface Data

| Surface | | | | | |
|---|---|---|---|---|---|
| Number | KA | A3 | A4 | A5 | A6 |
| 2 | −2.9660324E−01 | −7.0555880E−02 | 7.5752504E−01 | −5.5429166E+00 | 3.8621134E+01 |
| 3 | −3.3717036E+01 | −7.8406571E−02 | 5.4650779E−01 | −1.1514239E+00 | −1.3711185E+00 |
| 4 | −4.3327497E+02 | −8.2504197E−03 | −3.8563077E−03 | −2.0389300E−01 | 9.9273119E+00 |
| 5 | 8.5586959E−01 | 5.7047772E−02 | −4.8160511E−01 | 2.3045682E+00 | −4.7472500E+00 |
| 6 | −2.4891331E+03 | 2.0747956E−01 | 3.3013405E−01 | −3.5867149E+00 | 7.6781272E+00 |
| 7 | −1.2344052E+01 | 3.2976152E−02 | −4.6330739E−01 | 3.9256046E+00 | −2.6286025E+01 |
| 8 | −5.9443668E−01 | −2.8724409E−02 | 1.3340036E−01 | 6.3572094E−01 | −7.1450031E+00 |
| 9 | −3.8528629E−01 | 4.8360085E−03 | 3.3695869E−01 | −8.0733365E−01 | 4.4752001E+00 |
| 10 | 1.5378638E+00 | −1.2031829E−01 | 4.2393351E−01 | −1.2516571E+00 | 3.3795373E+00 |
| 11 | −8.1936758E−02 | −1.4875421E−02 | −8.9853110E−01 | 1.6578597E+00 | −2.2214637E+00 |
| | A7 | A8 | A9 | A10 | A11 |
| 2 | −2.2627966E+02 | 9.8509738E+02 | −3.0943320E+03 | 7.0772315E+03 | −1.1895997E+04 |
| 3 | 9.3166427E+00 | −1.0729154E+01 | −5.5155465E+00 | 1.4229117E+01 | −2.0305592E+00 |
| 4 | −9.0241421E+01 | 4.4231861E+02 | −1.4144300E+03 | 3.2048742E+03 | −5.3238963E+03 |
| 5 | 2.0359124E+00 | 9.9756785E+00 | −1.6913311E+01 | 5.8837279E+00 | 1.2671821E−01 |
| 6 | −3.2668449E+00 | −1.4268568E+01 | 2.3707192E+01 | −5.6932033E+00 | −9.6100558E+00 |
| 7 | 1.1978434E+02 | −3.9375662E+02 | 9.5016966E+02 | −1.6908155E+03 | 2.2102284E+03 |
| 8 | 3.1930568E+01 | −9.3199685E+01 | 1.9605461E+02 | −3.0432833E+02 | 3.4844490E+02 |
| 9 | −1.8477521E+01 | 4.8216580E+01 | −8.7597825E+01 | 1.1650724E+02 | −1.1459330E+02 |
| 10 | −7.9273607E+00 | 1.4367611E+01 | −1.9319410E+01 | 1.8940671E+01 | −1.3381356E+01 |
| 11 | 3.2834166E+00 | −4.9835479E+00 | 6.0674379E+00 | −5.3967371E+00 | 3.4437948E+00 |
| | A12 | A13 | A14 | A15 | A16 |
| 2 | 1.4623115E+04 | −1.2809980E+04 | 7.5616711E+03 | −2.6868593E+03 | 4.3252221E+02 |
| 3 | 1.3844597E+01 | −5.4985706E+01 | 6.1608210E+01 | −2.7967537E+01 | 4.2100200E+00 |
| 4 | 6.4854461E+03 | −5.6354521E+03 | 3.2941438E+03 | −1.1551891E+03 | 1.8277076E+02 |
| 5 | 1.4468563E+01 | −1.6421122E+01 | −5.5652465E+00 | 1.5386840E+01 | −5.9858342E+00 |
| 6 | −9.3985743E+00 | 3.0612759E+01 | −2.1916992E+01 | 5.0623386E+00 | 1.0766956E−01 |
| 7 | −2.0920950E+03 | 1.3922219E+03 | −6.1642398E+02 | 1.6276929E+02 | −1.9379006E+01 |
| 8 | −2.9098723E+02 | 1.7320018E+02 | −7.0029520E+01 | 1.7307109E+01 | −1.9748863E+00 |
| 9 | 8.2169621E+01 | −4.1547400E+01 | 1.3970408E+01 | −2.7943136E+00 | 2.5113423E−01 |
| 10 | 6.7114937E+00 | −2.3253589E+00 | 5.2825202E−01 | −7.0712826E−02 | 4.2244878E−03 |
| 11 | −1.5622154E+00 | 4.9289535E−01 | −1.0301298E−01 | 1.2829579E−02 | −7.1985126E−04 |

TABLE 19
Reference
Example 10
f = 4.09, Bf = 1.10

| Si | Ri | Di | Ndj | νdj |
|---|---|---|---|---|
| 1 | ∞ | −0.20 | | |
| (aperture stop) | | | | |
| *2 | 1.4902 | 0.63 | 1.54488 | 54.87 |
| *3 | −4.1078 | 0.06 | | |
| *4 | −6.5154 | 0.27 | 1.63351 | 23.63 |
| *5 | 2.7606 | 0.50 | | |
| *6 | 5.9127 | 0.32 | 1.63351 | 23.63 |
| *7 | 10.2706 | 0.25 | | |
| *8 | −1.7996 | 0.77 | 1.54488 | 54.87 |
| *9 | −0.9160 | 0.34 | | |
| *10 | −9.3043 | 0.31 | 1.54488 | 54.87 |
| *11 | 1.2717 | 0.54 | | |
| 12 | ∞ | 0.30 | 1.56700 | 37.80 |
| 13 | ∞ | 0.37 | | |
| 14 | ∞ | | | |
| (imaging surface) | | | | |

*aspherical surface

TABLE 20
Reference Example 10: Aspherical Surface Data

| Surface | | | | | |
|---|---|---|---|---|---|
| Number | KA | A3 | A4 | A5 | A6 |
| 2 | −2.2112235E−01 | −6.5587100E−02 | 7.1984024E−01 | −5.4173584E+00 | 3.8430214E+01 |
| 3 | −3.2493337E+01 | −6.6336814E−02 | 5.3953295E−01 | −1.1423819E+00 | −1.3973457E+00 |
| 4 | −3.9773737E+02 | −1.6406661E−02 | 1.4387922E−02 | −1.6783339E−01 | 9.9184582E+00 |
| 5 | 8.7950432E−01 | 6.3598341E−02 | −4.7093268E−01 | 2.3115277E+00 | −4.7382986E+00 |
| 6 | −2.4174218E+03 | 1.9836769E−01 | 3.0586238E−01 | −3.5831228E+00 | 7.6829739E+00 |
| 7 | −1.6191294E+01 | 3.5124985E−02 | −4.8133267E−01 | 3.9253269E+00 | −2.6281853E+01 |
| 8 | −6.5061042E−01 | −2.8393795E−02 | 1.4532163E−01 | 6.3779768E−01 | −7.1479942E+00 |
| 9 | −5.4197480E−01 | −2.5166210E−02 | 3.5269064E−01 | −8.0539675E−01 | 4.4768039E+00 |
| 10 | 1.3131958E+00 | −1.0708390E−01 | 4.2586783E−01 | −1.2502804E+00 | 3.3795746E+00 |
| 11 | −3.2151174E−02 | −1.7504795E−02 | −8.9453847E−01 | 1.6555661E+00 | −2.2220858E+00 |
| | A7 | A8 | A9 | A10 | A11 |
| 2 | −2.2622513E+02 | 9.8522982E+02 | −3.0945013E+03 | 7.0773859E+03 | −1.1896066E+04 |
| 3 | 9.2789083E+00 | −1.0792588E+01 | −5.3264008E+00 | 1.4175193E+01 | −2.0442024E+00 |
| 4 | −9.0274778E+01 | 4.4227986E+02 | −1.4143310E+03 | 3.2048570E+03 | −5.3239076E+03 |
| 5 | 2.0511229E+00 | 9.9982977E+00 | −1.6895011E+01 | 5.8644197E+00 | 5.6775319E−02 |
| 6 | −3.2645443E+00 | −1.4268947E+01 | 2.3704500E+01 | −5.6960546E+00 | −9.6128764E+00 |
| 7 | 1.1978690E+02 | −3.9375649E+02 | 9.5016872E+02 | −1.6908172E+03 | 2.2102268E+03 |
| 8 | 3.1927740E+01 | −9.3201405E+01 | 1.9605418E+02 | −3.0432826E+02 | 3.4844530E+02 |
| 9 | −1.8476993E+01 | 4.8216656E+01 | −8.7597993E+01 | 1.1650712E+02 | −1.1459346E+02 |
| 10 | −7.9275113E+00 | 1.4367516E+01 | −1.9319447E+01 | 1.8940651E+01 | −1.3381359E+01 |
| 11 | 3.2835255E+00 | −4.9833987E+00 | 6.0674918E+00 | −5.3967364E+00 | 3.4437853E+00 |
| | A12 | A13 | A14 | A15 | A16 |
| 2 | 1.4623008E+04 | −1.2810084E+04 | 7.5619571E+03 | −2.6869085E+03 | 4.3245318E+02 |
| 3 | 1.3866395E+01 | −5.5081818E+01 | 6.1643831E+01 | −2.8002209E+01 | 4.2589702E+00 |
| 4 | 6.4854453E+03 | −5.6354282E+03 | 3.2941428E+03 | −1.1551705E+03 | 1.8273193E+02 |
| 5 | 1.4397504E+01 | −1.6445566E+01 | −5.3573495E+00 | 1.5818344E+01 | −6.4649916E+00 |
| 6 | −9.3999991E+00 | 3.0612465E+01 | −2.1916928E+01 | 5.0635354E+00 | 1.1036233E−01 |
| 7 | −2.0920963E+03 | 1.3922211E+03 | −6.1642419E+02 | 1.6276954E+02 | −1.9378179E+01 |
| 8 | −2.9098683E+02 | 1.7320051E+02 | −7.0029434E+01 | 1.7307029E+01 | −1.9749856E+00 |
| 9 | 8.2169550E+01 | −4.1547433E+01 | 1.3970407E+01 | −2.7942998E+00 | 2.5116023E−01 |
| 10 | 6.7114912E+00 | −2.3253584E+00 | 5.2825217E−01 | −7.0712726E−02 | 4.2246635E−03 |
| 11 | −1.5622201E+00 | 4.9289409E−01 | −1.0301349E−01 | 1.2829636E−02 | −7.1960369E−04 |

TABLE 21
Reference
Example 11
f = 4.10, Bf = 1.16

| Si | Ri | Di | Ndj | νdj |
|---|---|---|---|---|
| 1 | ∞ | −0.21 | | |
| (aperture stop) | | | | |
| *2 | 1.4615 | 0.63 | 1.54488 | 54.87 |
| *3 | −4.1081 | 0.06 | | |
| *4 | −6.3225 | 0.27 | 1.63351 | 23.63 |
| *5 | 2.5559 | 0.50 | | |
| *6 | 5.6267 | 0.31 | 1.63351 | 23.63 |
| *7 | 16.1757 | 0.25 | | |
| *8 | −1.6983 | 0.83 | 1.54488 | 54.87 |
| *9 | −0.9102 | 0.27 | | |
| *10 | −11.3133 | 0.36 | 1.54488 | 54.87 |
| *11 | 1.3052 | 0.54 | | |
| 12 | ∞ | 0.30 | 1.56700 | 37.80 |
| 13 | ∞ | 0.43 | | |
| 14 | ∞ | | | |
| (imaging surface) | | | | |

*aspherical surface

TABLE 22
Reference Example 11: Aspherical Surface Data

| Surface | | | | | |
|---|---|---|---|---|---|
| Number | KA | A3 | A4 | A5 | A6 |
| 2 | −2.1903787E−01 | −6.2417941E−02 | 7.2296283E−01 | −5.4258463E+00 | 3.8462485E+01 |
| 3 | −3.2977358E+01 | −5.8031255E−02 | 5.4743731E−01 | −1.1435704E+00 | −1.3964936E+00 |
| 4 | −4.0056782E+02 | −8.4231838E−03 | 1.1959757E−02 | −1.7137745E−01 | 9.9189146E+00 |
| 5 | 8.9761657E−01 | 6.5279927E−02 | −4.6785104E−01 | 2.3098556E+00 | −4.7422165E+00 |
| 6 | −2.4342065E+03 | 2.1946251E−01 | 3.0806747E−01 | −3.5807925E+00 | 7.6843336E+00 |
| 7 | −1.0737338E+01 | 3.7869379E−02 | −4.6885170E−01 | 3.9244938E+00 | −2.6285330E+01 |
| 8 | −6.1513548E−01 | −3.7086325E−02 | 1.3811045E−01 | 6.3492546E−01 | −7.1478199E+00 |
| 9 | −4.0481100E−01 | 6.8666152E−03 | 3.4194344E−01 | −8.0697791E−01 | 4.4762029E+00 |
| 10 | 2.2700481E+00 | −1.0927860E−01 | 4.2618476E−01 | −1.2503006E+00 | 3.3795841E+00 |
| 11 | −7.3437551E−02 | −1.1286407E−02 | −8.9627326E−01 | 1.6558259E+00 | −2.2220716E+00 |
| | A7 | A8 | A9 | A10 | A11 |
| 2 | −2.2623445E+02 | 9.8521259E+02 | −3.0944868E+03 | 7.0773687E+03 | −1.1896050E+04 |
| 3 | 9.2832035E+00 | −1.0781244E+01 | −5.3693790E+00 | 1.4184501E+01 | −2.0399497E+00 |
| 4 | −9.0275900E+01 | 4.4227660E+02 | −1.4143540E+03 | 3.2048619E+03 | −5.3238934E+03 |
| 5 | 2.0476044E+00 | 9.9977103E+00 | −1.6889923E+01 | 5.8805281E+00 | 7.9106703E−02 |
| 6 | −3.2643918E+00 | −1.4269336E+01 | 2.3703876E+01 | −5.6966481E+00 | −9.6134789E+00 |
| 7 | 1.1978442E+02 | −3.9375767E+02 | 9.5016837E+02 | −1.6908171E+03 | 2.2102270E+03 |
| 8 | 3.1928749E+01 | −9.3200705E+01 | 1.9605450E+02 | −3.0432830E+02 | 3.4844511E+02 |
| 9 | −1.8477359E+01 | 4.8216529E+01 | −8.7597997E+01 | 1.1650717E+02 | −1.1459341E+02 |
| 10 | −7.9275030E+00 | 1.4367517E+01 | −1.9319449E+01 | 1.8940649E+01 | −1.3381360E+01 |
| 11 | 3.2834824E+00 | −4.9834230E+00 | 6.0674824E+00 | −5.3967386E+00 | 3.4437850E+00 |
| | A12 | A13 | A14 | A15 | A16 |
| 2 | 1.4623029E+04 | −1.2810063E+04 | 7.5619052E+03 | −2.6869030E+03 | 4.3245591E+02 |
| 3 | 1.3868618E+01 | −5.5076883E+01 | 6.1653843E+01 | −2.7984778E+01 | 4.2280169E+00 |
| 4 | 6.4854569E+03 | −5.6354327E+03 | 3.2941247E+03 | −1.1551858E+03 | 1.8275859E+02 |
| 5 | 1.4404319E+01 | −1.6452023E+01 | −5.3989131E+00 | 1.5759387E+01 | −6.3920652E+00 |
| 6 | −9.4007283E+00 | 3.0611770E+01 | −2.1917501E+01 | 5.0630446E+00 | 1.1001619E−01 |
| 7 | −2.0920962E+03 | 1.3922211E+03 | −6.1642436E+02 | 1.6276921E+02 | −1.9378639E+01 |
| 8 | −2.9098703E+02 | 1.7320034E+02 | −7.0029523E+01 | 1.7307027E+01 | −1.9748850E+00 |
| 9 | 8.2169581E+01 | −4.1547417E+01 | 1.3970410E+01 | −2.7943035E+00 | 2.5115351E−01 |
| 10 | 6.7114908E+00 | −2.3253586E+00 | 5.2825215E−01 | −7.0712694E−02 | 4.2246991E−03 |
| 11 | −1.5622200E+00 | 4.9289426E−01 | −1.0301341E−01 | 1.2829685E−02 | −7.1957655E−04 |

TABLE 23
Values Related to Conditional Formulae

| For- | Con- | Exam- | Exam- | Exam- | Exam- | Exam- | Exam- |
|---|---|---|---|---|---|---|---|
| mula | dition | ple 1 | ple 2 | ple 3 | ple 4 | ple 5 | ple 6 |
| (1) | f/f1 | 1.60 | 1.64 | 1.80 | 1.67 | 1.74 | 1.60 |
| (2) | f/f2 | −0.91 | −0.94 | −1.05 | −1.07 | −1.23 | −0.99 |
| (3) | f/f3 | −0.21 | −0.25 | −0.25 | −0.11 | −0.03 | −0.18 |
| (4) | f/f4 | 2.03 | 2.06 | 2.00 | 2.04 | 1.92 | 1.98 |
| (5) | f/f5 | −2.02 | −2.08 | −2.08 | −2.26 | −2.05 | −2.01 |
| (6) | νd3 | 23.63 | 25.48 | 23.63 | 23.63 | 23.63 | 23.63 |

| | | Reference | | Reference | Reference | Reference |
|---|---|---|---|---|---|---|
| For- | Con- | Exam- | Exam- | Exam- | Exam- | Exam- |
| mula | dition | ple 7 | ple 8 | ple 9 | ple 10 | ple 11 |
| (1) | f/f1 | 1.53 | 1.65 | 1.79 | 1.95 | 1.99 |
| (2) | f/f2 | −0.88 | −0.85 | −1.25 | −1.35 | −1.44 |
| (3) | f/f3 | −0.20 | −0.25 | 0.24 | 0.19 | 0.30 |
| (4) | f/f4 | 2.11 | 2.00 | 1.65 | 1.56 | 1.56 |
| (5) | f/f5 | −2.12 | −2.18 | −2.04 | −2.01 | −1.93 |
| (6) | νd3 | 23.63 | 25.48 | 25.48 | 23.63 | 23.63 |

What is claimed is:

1. An imaging lens consisting essentially of five lenses, including:
a first lens having a positive refractive power and a convex surface toward the object side;
a second lens having a concave surface toward the image side;
a third lens having a negative refractive power and a concave surface toward the image side;
a fourth lens of a meniscus shape having a convex surface toward the image side; and
a fifth lens of a biconcave shape, provided in this order from the object side;
the imaging lens satisfying the following conditional formula:
1.58<f/f1<3 (1-2)
wherein f is the focal length of the entire system, and f1 is the focal length of the first lens.

2. An imaging lens as defined in claim 1, wherein:
the second lens has a negative refractive power.

3. An imaging lens as defined in claim 1, wherein:
the fourth lens has a positive refractive power.

4. An imaging lens as defined in claim 1 that further satisfies the conditional formula below:
−3<f/f2<−0.7 (2)
wherein f2 is the focal length of the second lens.

5. An imaging lens as defined in claim 1 that further satisfies the conditional formula below:
1.5<f/f4<2.3 (4)
wherein f4 is the focal length of the fourth lens.

6. An imaging lens as defined in claim 1 that further satisfies the conditional formula below:
−2.5<f/f5<−1.5 (5)
wherein f5 is the focal length of the fifth lens.

7. An imaging lens as defined in claim 1, wherein:
the second lens is of a biconcave shape.

8. An imaging lens as defined in claim 1 that further satisfies the conditional formula below:
1.58<f/f1<2 (1-3).

9. An imaging lens as defined in claim 1 that further satisfies the conditional formula below:
−1.5<f/f2<−0.75 (2-1)
wherein f2 is the focal length of the second lens.

10. An imaging lens as defined in claim 1 that further satisfies the conditional formula below:
1.7<f/f4<2.1 (4-1)
wherein f4 is the focal length of the fourth lens.

11. An imaging lens as defined in claim 1 that further satisfies the conditional formula below:
−2.2<f/f5<−1.7 (5-1)
wherein f5 is the focal length of the fifth lens.

12. An imaging lens as defined in claim 1 that further satisfies the conditional formula below:
−0.4<f/f3<0 (3)
wherein f3 is the focal length of the third lens.

13. An imaging lens as defined in claim 12 that further satisfies the conditional formula below:
−0.3<f/f3<−0.12 (3-1).

14. An imaging lens as defined in claim 1 that further satisfies the conditional formula below:
νd3<30 (6)
wherein νd3 is the Abbe's number of the third lens with respect to the d line.

15. An imaging lens as defined in claim 14 that further satisfies the conditional formula below:
νd3<26 (6-1).

16. An imaging apparatus equipped with the imaging lens defined in claim 1.
